(19) United States
(12) Patent Application Publication
(10) Pub. No.: US 2023/0094417 A1
(43) Pub. Date: Mar. 30, 2023

(54) PROTECTIVE WRAP FOR REGULATING FLUID INFILTRATION AND METHODS OF MAKING, INSTALLING, AND USING THE SAME

(71) Applicant: KINGSPAN INSULATION LLC, Atlanta, GA (US)

(72) Inventors: Eugenio G. Varona, Marietta, GA (US); Ming Xie, Marietta, GA (US); Raymond Varona, Winchester, VA (US)

(73) Assignee: KINGSPAN INSULATION LLC, Atlanta, GA (US)

(21) Appl. No.: 17/947,065

(22) Filed: Sep. 16, 2022

Related U.S. Application Data
(60) Provisional application No. 63/245,069, filed on Sep. 16, 2021.

(51) Int. Cl. B32B 5/02; B32B 3/30; E04B 1/62; E04B 1/70

(52) U.S. Cl. CPC B32B 5/024; B32B 3/30; E04B 1/625; E04B 1/70; B32B 27/12

(57) ABSTRACT

The present disclosure provides for protective drainage wraps having improved properties, including fluid handling and structural integrity. The protective material barrier constructions, such as wraps, provide protection to surfaces, such as walls of buildings. The present disclosure provides for methods of making, using, and installing such protective material barrier constructions.

### CROSS-REFERENCE TO RELATED APPLICATIONS

The present application claims the benefit of U.S. Provisional Patent Application No. 63/245,069 (pending), filed on Sep. 16, 2021, and entitled “Protective Material Barrier System and Product, and Method of Using, Installing, and Manufacturing Protective Wrap System and Product,” the entirety of which is incorporated herein and made a part of the present disclosure.

### FIELD

The present disclosure relates, generally, to protective material barrier constructions, such as wraps, for providing protection to surfaces, such as walls of buildings. The present disclosure also relates to methods of making, using, and installing such protective material barrier constructions.

### BACKGROUND

Housewrap (or house wrap) is used to protect buildings from fluid infiltration, such as air and water infiltration. Housewrap is typically installed on a building between sheathing of the building and exterior siding (e.g., bricks) of the building. Housewrap is installed to protect the building from weather and/or environmental elements, such as rain.

There have been many different commercial protective wraps used in the construction of buildings, such as residential and commercial construction. Commercial protective wraps are used to protect against air infiltration and damaging moisture build-up. Air infiltration may occur in typical construction through, among other places, sheathing seams and cracks around windows and doors. Moisture build-up can occur externally in the wall cavity from, for example, leaking exterior finishes or coverings, and cracks around windows and doors.

Commercial protective wraps are typically used as secondary weather barriers in buildings behind exterior finishes or coverings such as siding, brick, stone, masonry, stucco and concrete veneers. Stucco may be synthetic based (e.g., a polymer-based stucco) or cementitious (a mixture of Portland cement, lime and sand). One type of stucco system, exterior insulation finish system (drainage EIFS), typically involves using a drainage plane, an insulation board, and a wire or synthetic mesh that accepts a cementitious coating. In stucco systems, protective wraps are not typically installed directly in contact with the cementitious coatings.

Both woven and non-woven commercial protective wraps are commonly used in the construction of buildings. The strength properties of woven wraps are typically much higher than the strength properties of non-woven wraps. Some woven wraps are translucent, which assists in locating studs, as well as window and door openings. Non-woven wraps, however, generally have higher permeabilities than woven wraps.

Commercial protective wraps, such as non-woven wraps, woven-wraps and cross-laminated wraps, also may be micro-perforated so as to allow moisture vapor to pass therethrough. Most non-woven commercial protective wraps (such as spun bonded polyolefin wraps) are not perforated, however, because the processes used in forming the wraps result in a structure that inherently allows the moisture vapor to pass through the wrap.

It would be desirable to have a protective wrap that provides for improved fluid handling as well as additional improved features.

### BRIEF SUMMARY

In one aspect, a material barrier systems, apparatus, or product a system or barrier is provided that incorporates cross-woven or cross-laminate materials as an integral layer, and, preferably, a layered portion comprising such cross-laminate or cross-woven materials.

Some embodiments include a protective drainage wrap. The wrap includes a base web having cross-woven or cross-laminate tape elements including first tape elements extending in a drainage direction and second tape elements extending in a direction that is transverse to the drainage direction. The base web presents a front surface and a back surface respectively defining a front and back of the base web. A plurality of spaced apart, elongated drainage strands are supported on the front of the web and extending in the drainage direction, wherein the strands are hydrophilic.

Some embodiments include a protective drainage wrap for placement intermediate a structure and an external environment. A frontward direction and a backward direction respectively corresponds to a direction toward the external environment and an opposite direction toward the structure. The wrap includes abase web including cross-woven or cross-laminate tape elements including first tape elements extending in a drainage direction and second tape elements extending in a direction transverse to the drainage direction. The tape elements together present a continuous front surface of the base web and a back surface of the web. A plurality of spaced apart, elongated drainage strands are supported frontward of the front surface of the base web and extending in the drainage direction.

Some embodiments include a protective drainage wrap. The wrap includes a base web including a cross-woven or cross-laminate tape elements including first tape elements extending in a drainage direction and second tape elements extending in a direction transverse to the drainage direction. A front surface of said base web is characterized by a plurality of spaced apart troughs each extending in the drainage direction.

Some embodiments include a protective drainage wrap including a base web including cross-woven or cross-laminate tape elements including first tape elements extending in a drainage direction and second tape elements extending in a direction transverse to the drainage direction. The base web presents a back surface and a front surface. A vapor-permeable and liquid impermeable barrier layer is situated adjacent the back surface of the base web. A nonwoven layer is situated on a back surface of said barrier layer and the barrier layer is situated intermediate said base web and said nonwoven layer.

Some embodiments include a protective drainage wrap including a base web having a cross-woven or cross-laminate tape elements including first tape elements extending in a drainage direction and second tape elements extending in a direction transverse to the drainage direction. The base web presents a front surface and a back surface respectively defining a front and back of the web. A plurality of spaced apart, elongated drainage yarns are supported on a front side of the base web and extending in the drainage direction. At least some of the second tape elements have a 3-D topographic front surface with ridges and channels extending in the drainage direction.

Some embodiments include a wrap that includes a base web including cross-woven or cross-laminate tape elements including first tape elements extending in a drainage direction and second tape elements extending in a direction transverse to the drainage direction. The base web presents a front surface of the base web and a back surface of the base web. A plurality of spaced apart, elongated drainage yarns are situated adjacent the front surface and extending in the drainage direction. A 3-D topographic front layer is situated over the base web and drainage yarns. The front layer have a laterally directed undulating front surface characterized by ridges and channels in the drainage direction.

Some embodiments include a protective drainage wrap that includes a base web having cross-woven or cross-laminate tape elements including first tape elements extending in a drainage direction and second tape elements extending in a direction that is transverse to the drainage direction. The base web presents a back surface and a front surface. A vapor-permeable and liquid impermeable barrier laver is situated adjacent the back surface of the base web, wherein the barrier layer is a non-porous monolithic film that is permeable to water molecules via molecular diffusion.

Some embodiments include a protective drainage wrap for placement intermediate a protected structure and an external environment. A frontward direction and a backward direction respectively corresponds to a direction toward the external environment and an opposite direction toward the structure. The wrap includes a base web comprising cross-woven or cross-laminate tape elements including first tape elements extending in a drainage direction and second tape elements extending in a direction transverse to the drainage direction. The base web presents a front surface of the web and a back surface of the base web. A plurality of spaced apart, elongated drainage yarns are supported adjacent the front surface of the base web and extending in the drainage direction. At least some of said tape elements are hydrophilic tape elements.

In one aspect, the present disclosure presents a protective drainage wrap including a cross-woven base layer or fabric with a preferably breathable solid layer portion and characterized by enhanced drainage functionality. In one embodiment, the barrier protection system is equipped with oriented drainage channels and the system utilizes capillarity-driven flow elements in addition to gravity-driven flow mechanisms in the traditional drainage regions. In one variation, the capillarity-driven drainage elements are elongated elements such as cords or yarns preferably made of hydrophilic, multilobal shaped fibers to accommodate higher fluid flows and compression resistance for maintaining overall drainage volume in the system. Furthermore, appropriate surface wettabilities may be provided to create paths to feed the wicking yarns.

In another aspect, the present disclosure presents a barrier protection system, including a protective drainage wrap, having a three-dimensional structure, either one or two-sided. In preferred embodiments, three-dimensional features or characteristics of the system provides for and maintains the desired drainage volume. The three-dimensional features also provide volume that contributes to evaporative drying due to air circulation. Further, in these embodiments, the desired three-dimensional features are created by the yarn and/or by surface topography, introduced by such mechanism as embossing or creping, for example.

In another aspect, a material barrier construction is provided including a base web equipped with a drainage surface and, further, drainage channels for quickly passing water and moisture downward from the system and from building surfaces, inducing primarily by gravity-driven flow. In a further aspect, the material barrier construction is provided with elongated hydrophilic capillarity-driven flow elements that act as conduits for passing water or moisture drawn into the element. In a further aspect, the capillarity-driven flow elements are incorporated into and made a part of a cross-woven base web of the wrap, and at least partly defines the cross-section of the base web and the drainage surfaces of the system, while also presenting a conduit for capillary-driven and/or gravity-driven flow to add to and assist drainage capabilities. The present disclosure further provides material selection and structural options (e.g., modifications) to enhance the capillarity-driven flow elements drainage functionality (e.g., the wicking mechanism and capillary flow mechanism inherent in the structure).

In another aspect, a protective drainage wrap is provided having a multi-laminate structure (preferably tri-laminate). In one variation, the barrier protection system incorporates a top layer of sheet with a topography of appropriately oriented drainage channels. The full sheet may be creped or embossed spunbond, nonwoven or film.

In another aspect, a material barrier construction is disclosed having a first portion including a cross-woven base web or cross-laminate material, a coating making up a second portion or base layer. Preferably, the coating includes a polyolefin, polyester, nylon or combinations thereof, and the first and second portions are disposed adjacent each other. In specific embodiments, the base web is made up of a network of a first material and a second material. The first material can have a first thickness and be oriented in the machine (i.e., relative to and transverse to a downstream or direction of drainage (or vertical) when installed) including a polyolefin, polyester, nylon or combinations thereof, the machine direction material. Preferably, the material in the other direction (cross-machine, transverse or direction of drainage) includes a polyolefin, polyester, nylon or combinations thereof, and is characterized by a second thickness. In a further aspect, the second thickness is at least two times greater than the first thickness so as to assist in providing drainage for moisture build-up. The present disclosure provides various improvements to this basic design, including in the selection of materials for system components, geometry and topography, and modification to material surfaces.

So that the manner in which the features and advantages of the systems, apparatus, products, and/or methods so of the present disclosure may be understood in more detail, a more particular description briefly summarized above may be had by reference to specific implementations of the barrier protection systems, apparatus, methods, and products that are illustrated in (some of) the appended drawings. It is to be noted, however, that the drawings illustrate specific implementations for illustration and are, therefore, not to be considered limiting of the disclosed concepts as it may include other, effective applications as well. It is noted, in particular, that the exemplary applications described herein relate to certain cross-woven barrier protection systems and methods, employing specific components and component arrangements described as protective drainage wraps. These specific constructions and more detailed variations thereof are not limiting of the concepts. The concepts described herein can be used with most known building constructions and building materials. Certain applications may employ less than all of the various aspects described herein.

### BRIEF DESCRIPTION OF THE DRAWINGS

So that the manner in which the features of the compositions, articles, systems and methods of the present disclosure may be understood in more detail, a more particular description briefly summarized above may be had by reference to the embodiments thereof which are illustrated in the appended drawings that form a part of this specification. It is to be noted, however, that the drawings illustrate only various exemplary embodiments and are therefore not to be considered limiting of the disclosed concepts as it may include other effective embodiments as well.

FIG. 1A is a simplified, plan view illustration of a barrier protection system and apparatus, or protective drainage wrap;

FIG. 1B is a cross-sectional view of the protective drainage wrap of FIG. 1A;

FIG. 1C is a simplified, plan view illustration of a barrier protection system and apparatus, or protective drainage wrap;

FIGS. 2A and 2B are cross-sectional views of protective drainage wraps installed on a building in accordance with embodiments of the present disclosure;

FIG. 3A is a simplified illustration, in plan view, of a protective drainage wrap incorporating an embossed cross-woven base web or fabric and optional interlaced, spaced-apart hydrophilic elongated capillary-driven drainage elements, in accordance with embodiments of the present disclosure;

FIGS. 3B and 3C are cross-sectional views of two alternative constructions of the protective drainage wrap of FIG. 3A in accordance with embodiments of the present disclosure;

FIG. 3D is an elevation view (I) and micro cross-sectional views (II, III, and IV) of hydrophilic capillary-driven drainage elements or conduits or fibers, in accordance with embodiments of the present disclosure;

FIG. 4A is a simplified illustration, in plan view, of another protective drainage wrap incorporating a cross-woven base web or fabric and optional interlaced spaced-apart hydrophilic capillary-driven drainage elements supported on hydrophilic cross-directional tape, in accordance with embodiments of the present disclosure;

FIGS. 4B and 4C are cross-sectional views of two alternative constructions of the protective drainage wrap of FIG. 4A in accordance with embodiments of the present disclosure;

FIG. 5A is a simplified illustration, in plan view, of another protective drainage wrap incorporating a cross-woven base web or fabric featuring hydrophilic cross-directional tape elements and optional interlaced spaced-apart hydrophilic capillary-driven drainage elements supported on hydrophilic cross-directional tape adjacent additional hydrophilic cross-directional tape, in accordance with embodiments of the present disclosure;

FIGS. 5B and 5C are cross-sectional views of two alternative constructions of the protective drainage wrap of FIG. 5A in accordance with embodiments of the present disclosure;

FIG. 6A is a simplified illustration, in plan view, of another protective drainage wrap incorporating an embossed cross-woven base web or fabric featuring hydrophilic cross-directional tape elements and optional interlaced spaced-apart hydrophilic capillary-driven drainage elements positioned within troughs formed by embossing, in accordance with embodiments of the present disclosure;

FIGS. 6B and 6C are cross-sectional views of two alternative constructions of the protective drainage wrap of FIG. 6A in accordance with embodiments of the present disclosure;

FIG. 7A is a simplified illustration, in plan view, of another protective drainage wrap incorporating a cross-woven base web or fabric featuring hydrophilic cross-directional tape elements and optional interlaced spaced-apart hydrophilic capillary-driven drainage elements supported on hydrophilic cross-directional tape and positioned within troughs formed by embossing, in accordance with embodiments of the present disclosure;

FIGS. 7B and 7C are cross-sectional views of two alternative constructions of the protective drainage wrap of FIG. 7A in accordance with embodiments of the present disclosure;

FIG. 8A is a simplified illustration, in plan view, of another protective drainage wrap incorporating a cross-woven base web or fabric featuring creped machine direction tape elements and optional interlaced spaced-apart hydrophilic capillary-driven drainage elements, in accordance with embodiments of the present disclosure;

FIGS. 8B-8E are various cross-sectional views including alternative constructions of the protective drainage wrap of FIG. 8A in accordance with embodiments of the present disclosure;

FIGS. 9A-9C are cross-sectional views of a tri-layer laminate protective drainage wrap incorporating a cross-woven base web or fabric and an optional top layer featuring a desired three-dimensional topography and a nonwoven bottom layer, in accordance with embodiments of the present disclosure;

FIG. 10A is a simplified illustration, in plan view, of an alternate protective drainage wrap incorporating a cross-woven base web or fabric featuring alternating arrangement of hydrophilic and hydrophobic machined-direction tape elements, in accordance with embodiments of the present disclosure;

FIG. 10B is a cross-sectional view of the protective drainage wrap of FIG. 10A in accordance with embodiments of the present disclosure;

FIG. 11 is a flow chart of a method of making a protective drainage wrap in accordance with embodiments of the present disclosure;

FIG. 12 is a flow chart of a method of installing a protective drainage wrap in accordance with embodiments of the present disclosure;

FIG. 13 is a schematic of a system for making a protective drainage wrap in accordance with embodiments of the present disclosure; and

FIG. 14 is a simplified schematic of an installation of a wrap in accordance with embodiments of the present disclosure.

### DETAILED DESCRIPTION

The present disclosure includes, generally, protective material barrier constructions and/or systems and apparatus for providing material barrier protection relative to an adjacent surface, as well as corresponding methods of barrier protection, installation, and manufacture. The present disclosure includes, more specifically, such systems, apparatus, products, and/or methods of barrier protection in respect of or for building surfaces against weather or environmental or other elements. The present disclosure includes systems of material barrier protection, which may include various components, including traditional construction components and building materials such as coatings, sheathing, panels, frame elements and the like, as well as specific components, layers, surface treatments and materials for use with other conventional or traditional building materials and constructions.

The protective drainage wraps, sometimes referred to herein as a “system” or a “construction” or “wrap”, whether single-layered or multi-layered, optionally present extended and substantially continuous surfaces, measurable by area and thickness. The protective drainage wraps are flexible, such that the wraps can be applied upon target surfaces or spaces between surfaces of various shapes and sizes. Embodiments of the wraps can be applied over an extended surface area and into and about different, but connected, areas and contours. In this respect, systems and constructions disclosed herein are described, in terms of application or installations, as wraps or as being wrapped, particularly about or adjacent the external boundaries of a building. The use of such terminology as “wrap,” “wrapping,” and “wrapped” is not meant, however, to impart structural limitations on the type or class of construction material disclosed or on the method of application of the various systems and constructions described herein.

The protective drainage wraps disclosed herein are generally employed as secondary weather barriers installed, during building construction, behind exterior coverings such as siding. In some embodiments, for optimal effect, the wraps or wrap components or materials are designed or installed to be both water resistant and water vapor permeable. That is, the wraps can be designed to prevent water penetrating the external building coverings (e.g., siding) from intruding upon the covered internal layers; thereby, presenting a solid barrier that is aided by structural and/or material features exhibiting, enhancing, or effecting desirable drainage capabilities and evaporative effects.

The present disclosure is related to the subject matter disclosed in U.S. Pat. Nos. 6,550,212; 6,761,006; 6,869,901; 7,196,024; 8,334,223; 9,656,445; and 9,855,728, and, in certain respects, to modifications, alternatives, enhancements, and/or improvements to the systems, products, processes, techniques, and methodologies disclosed in these aforementioned patents. Accordingly, descriptions and illustrations, as well as claims and inventions provided in these aforementioned patents may serve well as background and further support for some of the concepts presented in the present disclosure, including certain technical problems addressed by these concepts. Thus, the present disclosure may be read in view of, and with reference to, these aforementioned patents for at least the purpose of facilitating understanding of the full scope and extent of the present disclosure. Specifically, descriptions of certain components or materials or techniques that are suitable for use with embodiments of the concepts introduced herein, including descriptions of yarns and cord elements, tape materials, and breathable coatings may be applicable to some embodiments disclosed herein. The entirety of these aforementioned patents are, therefore, incorporated herein and hereto, and made a part of the present disclosure. The protective wraps described in these aforementioned patents, most if not all of which are commonly owned or controlled with the assignee of the present application, are material layered systems and products used in building constructions to protect surfaces against air infiltration and moisture build-up. These systems may be weather-resistive barriers, which can also provide drainage functionality (hence, “protective drainage wraps”). As with previously-described systems and products (in the aforementioned patents), the material barrier systems of the present disclosure are intended for, and applied, installed, or inserted as layered materials or constructions intermediate an external siding or layer of the building construction and an internal structural component or layer, such as wood paneling. The wraps disclosed herein may be protective wraps, drainage wraps, or weather-resistant wraps. In some embodiments the exterior of the protective drainage wraps disclosed herein do not trap water but, rather, allow and facilitate the flow or movement of water downward along the wrap such that the water exits the wall system. For purposes of the present description of exemplary applications, reference is made specifically to the use of yarns as capillary-driven drainage elements, but, its noted that other hydrophilic, elongated elements with sufficient structural integrity and capillarity and the above features and characteristics may be used, to different degrees of effect. See “Capillary Flow of Liquid Water through Yarns: A Theoretical Model”, by Hend Almoughni and Hugh Gong, Textile Research Journal published online 22 Oct. 2014, http://trj.sagepub.com/content/early/2014/10/22/0040517514555797, which is incorporated herein by reference for background and made a part of the present disclosure.

### Protective Wraps

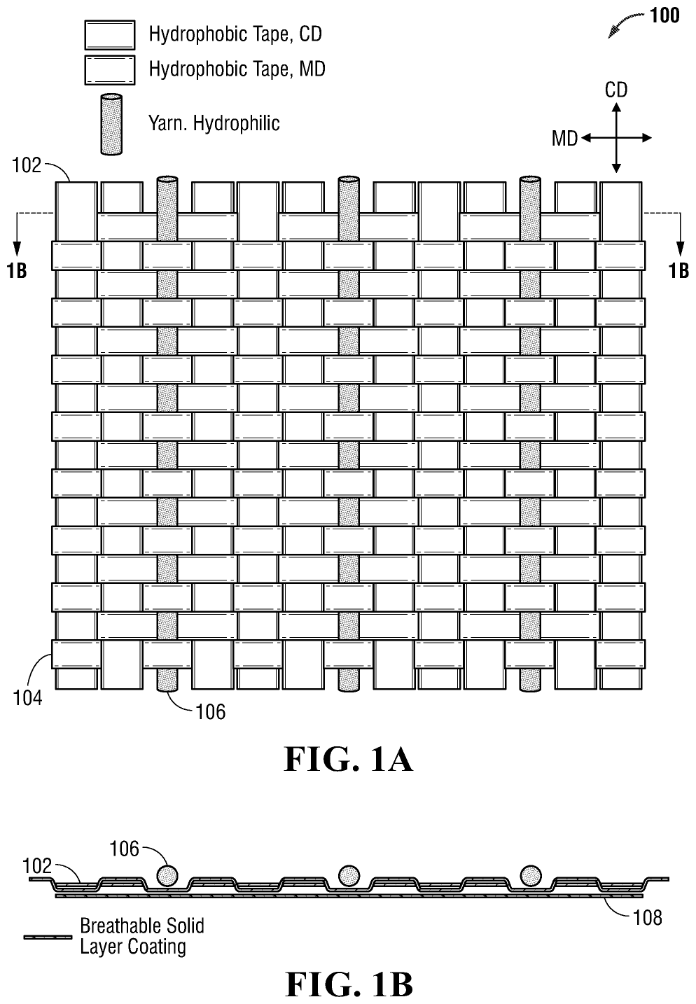

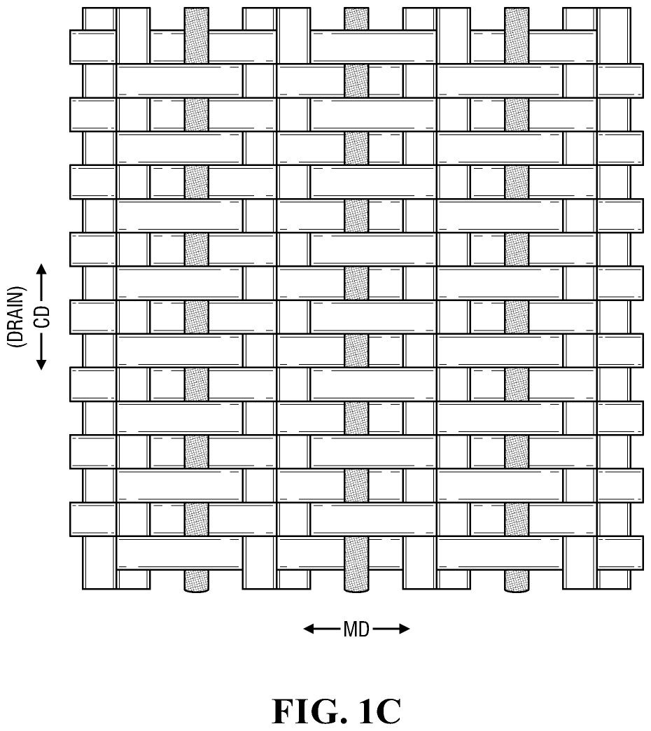

FIGS. 1A-1C depict barrier protection systems (i.e., protective drainage wraps) in accordance with those described in the aforementioned and incorporated patents, including U.S. Pat. No. 6,550,212. The depictions in FIGS. 1A-IC are included herein to facilitate the descriptions of the concepts introduced herein. Conventions and terminology previously used may be helpful, as well as reference made to the prior structures depicted, when considering the improvements and enhancements introduced herein. As will be evident, understanding of these improvements and enhancements, and of the various aspects and concepts, may be more readily achieved with reference and comparison to one such prior, base design of a protective drainage wrap.

With reference to FIGS. 1A-1C, protective drainage wrap 100 includes a cross-woven base web or network of fabric, including a plurality of hydrophobic cross-directional (CD) tapes 102 extending in the cross-direction (cross-machine direction or vertical or drainage direction in the drawing). The protective drainage wrap 100 includes a plurality of hydrophobic machine-directional (MD) tapes 104 extending in the machine-direction (horizontal or lateral direction in the drawing). The CD tapes 102 are weaved (interlaced) with the MD tapes 104 to produce a generally contiguous, cross-woven base web or fabric. The protective drainage wrap 100 includes a plurality of elongated hydrophilic yarns 106 that are spaced apart in the MD-direction, interlaced by the MD tapes 104, and directed in the CD-direction. The yarns 106 are directed such that when installed on a wall, the yarns 106 extend downward to provide capillary-driven drainage. With reference to FIG. 1B, the protective drainage wrap 100 includes a barrier layer 108 (sometimes referred to as a base layer) disposed beneath and adjacent the cross-woven base web formed by the tapes 102 and 104. The barrier layer 108 can be a breathable (i.e., air and vapor permeable), solid coating layer that is configured to prevent or resist the passage of liquid water while also exhibiting air and water vapor permeability. FIG. 1B also illustrates the spacing between the material components and layers of the protective drainage wrap 100 includes, including horizontal and vertical gaps between the yarns 106 and the CD tapes 102 on either side of the yarns 106. Reference may be made to the previously incorporated patents, including U.S. Pat. No. 6,550,212, to obtain details on the design, construction and functionalities of the depicted wraps of FIGS. 1A and 1B, including material selection and drainage features (e.g., of the channels and the yarn).

FIGS. 1A-1C also show the relative thickness of the yarns 106 as compared to the thickness of the tapes 102 and 104 and the barrier layer 108. When the protective drainage wrap 100 is installed, and an external layer or building material is placed adjacent and atop the protective drainage wrap 100, the yarns 106 act as spacers or bumpers that create or enhance a vertical gap between the fabric and the external layers. The yarn 106, tapes 102 and 104, and gap define a drainage channel which facilitates movement of water and moisture by gravity away from the building and building materials, as described in the aforementioned incorporated patents. FIG. 1C shows that the draining direction (i.e., the direction that liquid drains via gravity and/or capillarity), when installed on a structure, corresponds with the cross-direction of the protective drainage wraps described herein.

### Enhanced Protective Wraps

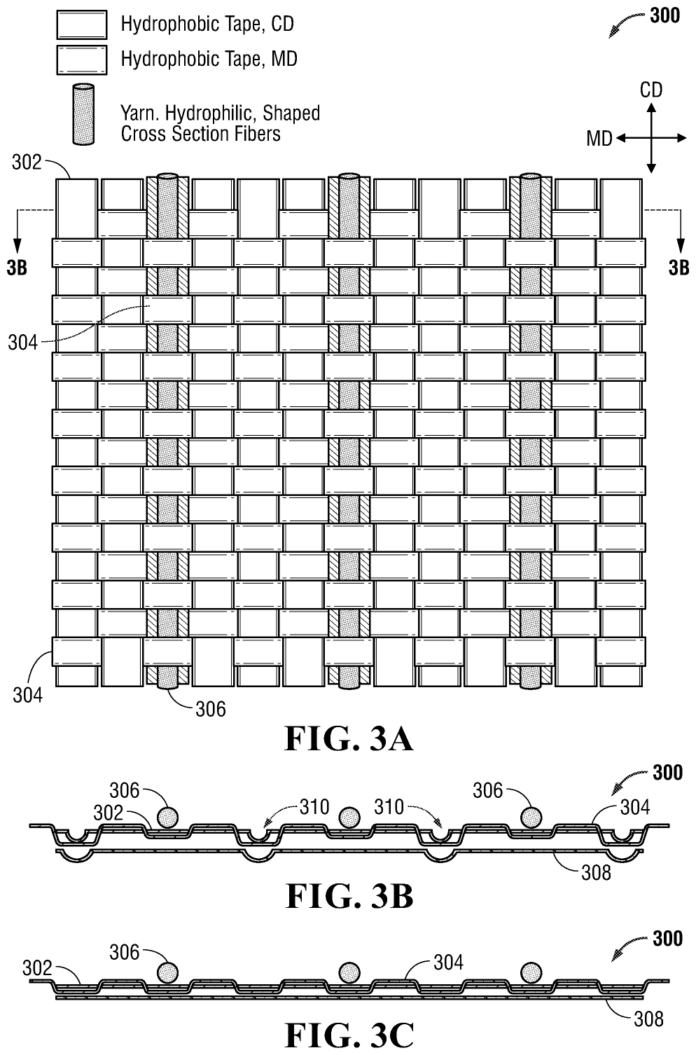

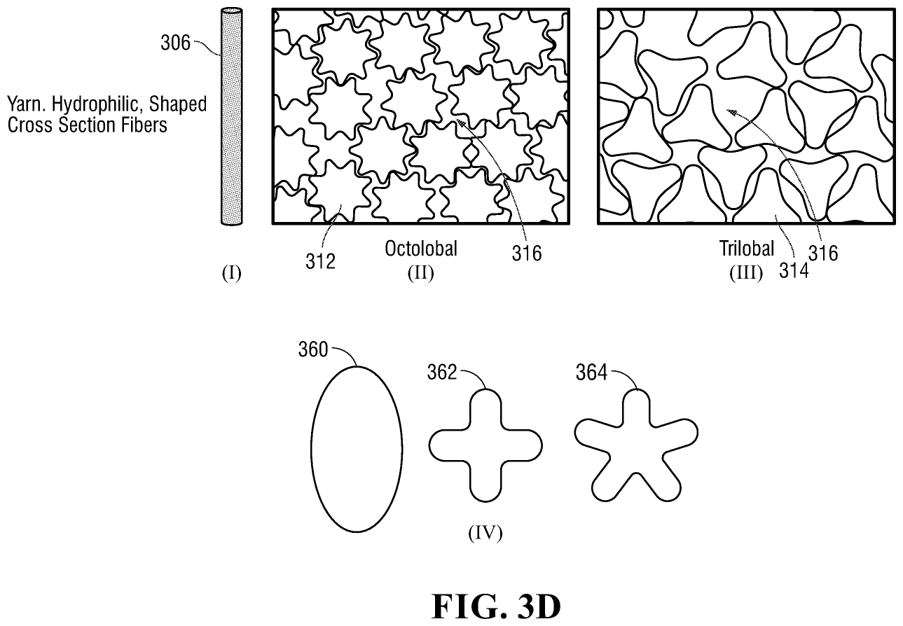

In one aspect, the barrier protection systems of the present disclosure include structural and/or material selection options that enhance drainage functionality by enhancing gravity-driven flow through the drainage channels described above, as well as capillary-driven flow via hydrophilic elements or conduits (e.g., yarns) that are located in spaced-apart relation adjacent the drainage channels. Specifically, the system designs provide new and/or enhanced capillary flow channels provided by, for example, bundles of hydrophilic fibers generally aligned in parallel (e.g., yarns or cords or monofilaments). Such drainage or flow mechanisms enhance the gravity-driven flow through the drainage channels (which, notably, is partly created and maintained by the thickness of the capillary flow elements—i.e., the elongated hydrophilic yarns or cords). As described in more detail below with reference to FIG. 3D, flow through the fiber bundles can be optimized by maximizing the internal volume in the fiber bundle and the compressional resistance of the fiber bundle (e.g., yarn) through, for example, the use of yarn composed of multi-lobal cross-sectional fibers. While yarn is disclosed as being used to form the capillary-driven drainage elements, the present disclosure is not limited to the use of yarn. Other hydrophilic, elongated elements with sufficient structural integrity and capillarity can be used in place of the yarns depicted in the Figures disclosed herein. The capillary-driven drainage elements can be at least partially formed by fiber bundles other than yarn and/or by strips or cords of other material, such as strips of low-density nonwoven that can be cross-laminated to a base web (weave of MD and CD tapes).

FIGS. 3A-14 provide illustrations of several variations and exemplary applications and/or embodiments of the barrier protection systems, apparatus, products, and methods according to the present disclosure, with particular focus on variations of systems and apparatus incorporating multiple functional layers or components including a cross-woven base web or fabric of interlaced elements (e.g., tapes) and, optionally, additional functional components or elements that are attached, integrated, or otherwise disposed adjacent and in functional relation with the cross-woven base web or fabric. In accordance with the present disclosure, FIGS. 3A-14 illustrate variations in the arrangement of these system elements as well as variations in each of the system elements. These variations and described features may generally be regarded as optional such that exemplary applications extend to systems, not depicted or described herein, that employ one or more of the features described, within the spirit of the concepts and aspects of the present disclosure. Additionally, one or more of the features described in FIGS. 3A-14 can be combined together to provide for synergistic enhancement of the properties of the protective drainage wraps disclosed herein.

### Shaped Protective Wraps

FIGS. 3A-3C illustrate a barrier protection system and apparatus according to one aspect of the present disclosure. The system and corresponding apparatus can be positioned internal of external members of building construction, such between siding, and intermediate of such external members and an internal member such as a framing member, sheathing or panel, which members require further coverage or protection from external, environmental elements (e.g., moisture). Thus, the systems disclosed herein can be positioned between sheathing and siding (e.g., bricks), for example. To facilitate further description, the systems disclosed herein are referred to as barrier protection systems or protective drainage wraps, noting that certain aspects described herein may present attributes or improvements less directed to drainage functionality than to other functionalities. The protective drainage wrap reduces moisture penetration to the sheathing or framing members. Typically, the protective drainage wrap is covered by an exterior covering such as siding, brick, stone, masonry, stucco (e.g., synthetic or cementitious) or concrete veneer.

FIG. 3A illustrates a protective drainage wrap 300 useful for attaching to structural members, such as sheathing or framing members. When installed, protective drainage wrap 300 can be used to reduce moisture penetration to underlying sheathing or framing members. Typically, the protective drainage wrap 300 is covered by an exterior covering such as siding. The protective drainage wrap 300 includes hydrophobic MD tape 304, hydrophobic CD tape 302, and hydrophilic yarn 306 weaved together to form a network or web. While described as including a weaved web or network, the protective drainage wrap is not limited to a particular form of fabric. The tapes 302 and 304 are woven together in a plain weave style, such that the MD tapes 304, also referred to as tapes, are oriented in the machine direction, and such that the CD tapes 302, which are also referred to as weft tapes, are oriented in the cross direction, which is generally orthogonal to the machine direction. When placed over structural members, the CD direction is generally a vertical direction relative to the structure (i.e., the drainage direction) and the MD direction is generally a horizontal direction relative to the structure. Throughout this disclosure, the terms “cross-directional” and “cross-direction” and “CD” are used to refer to the direction that is intended to be the direction of drainage along the protective drainage wrap or the direction, when installed, that drainage occurs. The drainage direction typically aligns with the direction of gravity, i.e., the liquid drains downwards towards the ground. Throughout this disclosure, the terms “machine-directional” and “machine-direction” and “MD” refers to a direction that is transverse to the CD. While “machine-directional” and “machine-direction” and “MD” may correspond with a machine or lateral direction associated with the manufacture of some embodiments of the protective drainage wrap, the directions disclosed herein are not limited by directionalities used during the manufacturing process.

The tapes 302 and 304 are woven together in an over-and-under sequence to form a cross-woven base web. The cross-woven base web can have an equal number of CD tapes and MD tapes, more CD tapes than MD tapes, or less CD tapes than MD tapes. As used herein, the “cross-woven base web” refers to the weaved fabric formed by the woven together CD tapes 302 and MD tapes 304. As shown in FIGS. 3A-3C, the hydrophilic yarn 306 is weaved with the CD and MD tapes 302 and 304 and, thus, incorporated into the cross-woven base web. The yarns 306 extend substantially in the CD direction and substantially parallel with the CD tapes 302. The yarns are positioned on top of at least some of the tapes. For example, as shown in FIGS. 3A-3C, the yarns 306 are positioned on top of one of the CD tapes 302, intermittently on top of alternating MD tapes 304, and intermittently beneath alternating MD tapes 304. Thus, the yarns 306 are structurally supported by the CD tapes 302 and the MD tapes 304 that are positioned beneath the yarns 306, and are maintained in position within the weave of the cross-woven base web by the MD tapes 304 that extend over the yarns 306.

The cross-woven base web formed by the weaved tapes 302 and 304 can be or present a solid continuous web or layer of material beneath the yarn 306. As shown in FIG. 3A, a CD tape 302 and portions of alternating MD tapes 304 are positioned underneath each yarn 306. As such, along an entire cross-directional extent of each yarn 306, a CD tape 302 (or a combination of a CD tape 302 and an MD tape 304) is positioned between the yarn 306 and the underlying barrier layer 308. While described as a barrier “layer” the barrier material is not limited to a particular form and method of application. Thus, in some embodiments the yarns 306 are maintained spaced apart from the barrier layer 308 and are not in contact with the barrier layer 308. The solid web or layer of material provided by the cross-woven base web that is beneath the yarn 306 can act to protect the yarn 306 from damage, such as during handling and installation. In embodiments where the CD tapes 302 positioned directly underneath the yarns 306 are hydrophobic, the CD tapes 302 reduce the penetration of liquid (also referred to as liquid breakthrough) through the cross-woven base web and to the base layer 308. Thus, the hydrophobic CD tapes 302 on which the yarns 306 are supported can prevent water from penetrating through the protective drainage wrap 300 to the barrier layer 308 on the backside of the protective drainage wrap 300.

The yarns 306 can have hydrophilic properties that enable the yarns 306 to wick moisture. For example, water along the surface of the protective drainage wrap 300 can be attracted to the yarns 306 due to the hydrophilic properties of the yarns 306. Water drawn into the yarns 306 can travel downward through the length of yarns 306 along the CD direction. The downward travel of water through the yarns 306 can be due, in part, to gravity and, further, in part to capillary-driven flow through the yarns 306. Thus, the yarns 306 can function as capillary-driven and gravity-driven drainage channels or conduits that facilitate water drainage downward and across the surface of tapes 302 and 304.

With the yarns 306 positioned on top of the CD tapes 302, the yarns 306 can absorb and wick away more liquid in comparison to a wrap in which no CD tape is positioned beneath and supporting the yarn along the CD extent of the yarn. For example, when the yarn 306 is saturated with a maximum amount of liquid therein, then the hydrophobic CD tape 302 supporting the yarn 306 can maintain the position of water at or near the yarn 306 until the yarn 306 is no longer saturated (after further wicking) and is able to absorb and wick away additional liquid from the CD tape 302.

As illustrated, the yarns 306 are positioned on every fourth CD tape 302. However, the wraps disclosed herein are not limited to this arrangement, and the yarns can be placed at more or less frequent intervals than is shown in the Figures. Additionally, the yarns may be evenly distributed with equal intervals between adjacent yarns (as shown) or the yarns may be distributed with unequal intervals.

The cross-woven base web formed of the weaved CD tape 302 and MD tape 304 provides tensile properties and high tear resistance to the protective drainage wrap 300, while the yarn 306 of the cross-woven base layer provides an integral drainage structure that is oriented downwards to direct water towards a bottom edge of the protective drainage wrap 300 (e.g., towards the ground when installed).

FIGS. 3B and 3C depict alternative cross-sectional views of the protective drainage wrap 300 of FIG. 3A, along line A-A. As shown in FIGS. 3B and 3C, the CD tapes 302 and yarn 306 of the protective drainage wrap 300 are supported on a breathable, solid barrier layer 308, which can be in the form of a coating or film, for example. The barrier layer 308 can provide liquid water resistance (i.e., can be substantially impermeable to liquid water) and water vapor permeability (i.e., can be vapor permeable to air and water vapor). FIG. 3B is a simplified at least partially exploded view showing the barrier layer 308 spaced apart from the base web; however, the barrier layer may be laminated directly onto the base web.

In some embodiments, the barrier layer 308 is a microporous film layer. The barrier layer 308 can be a microporous polymer films, such as those constructed from stretched polyolefins. For example, the barrier layer 308 can be an extruded and biaxially stretched CaCO₃ filled polypropylene, stretched polytetrafluoroethylene (PTFE), or precipitation-cast polyurethane. Such microporous film layers are vapor permeable via pores through the film. The relatively small size of the pores in these microporous films prevents the penetration of liquid water, but the interconnected pore structure allows for transmission of water vapor, air, and other gases.

In some embodiments, the base layer 308 can be monolithic extruded film. Such monolithic extruded films lack pores (i.e., are non-porous) and are permeable via molecular diffusion. The monolithic extruded films can be hydrophilic. The monolithic films present a continuous surfaces that is free of pores. The monolithic extruded films are impermeable to liquid water, but allow passaged of molecular water via diffusion through the film. Monolithic breathable films can transmit water vapor through an absorption-diffusion mechanism, such that the film is capable of absorbing gas and water molecules on one surface, transferring the molecules through the film, and releasing the molecules on the opposite surface. Examples of breathable monolithic films include thermoplastic elastomers (TPE), polar copolymers, and polyester elastomers such as Pebax® an Lotryl® polymers. Compared to microporous films, monolithic films have an increased ability to prevent the passage of liquid (i.e., act as a liquid barrier). The liquid barrier properties of a monolithic film are independent of the surface tension of the liquid to which the film is exposed. For example, the liquid barrier properties of a monolithic film are not substantially affected by the introduction of a surfactant (e.g., where water on the wrap has surfactant therein), which can cause the surface of the film to exhibit hydrophilicity.

In some embodiments, the barrier layer is a monolithic extruded film that is a smart vapor retarder that exhibits water vapor permeability that variable with relative humidity, such as a polyamide (nylon) or vinyl alcohol copolymer (EVOH, PVOH). That is, the smart vapor retarder can have increased vapor permeability with increased ambient humidity, and decreased vapor permeability with decreased ambient humidity. Thus, in humid conditions, the smart vapor retarder can allow for water molecules to pass therethrough via molecular diffusion through the film. Such a film can retard vapor diffusion in less-humid conditions, while allowing vapor transmission and drying in more humid conditions. The smart vapor retarder can be hygroscopic, such that the film absorbs water when exposed to ambient humidity. Water molecules can lodge between the molecules of the film, which can act as valves on a molecular scale, allowing water vapor to travel through the film. Some exemplary smart vapor retarders are manufactured by Arkema (https://hpp.arkema.com/en/markets-and-applications/chemical-industry-and-general-industry/breathable-films/) and Pebax Thermoplastic elastomers (https://www.mddionline.com/packaging/breathable-tpe-films-medical-applications).

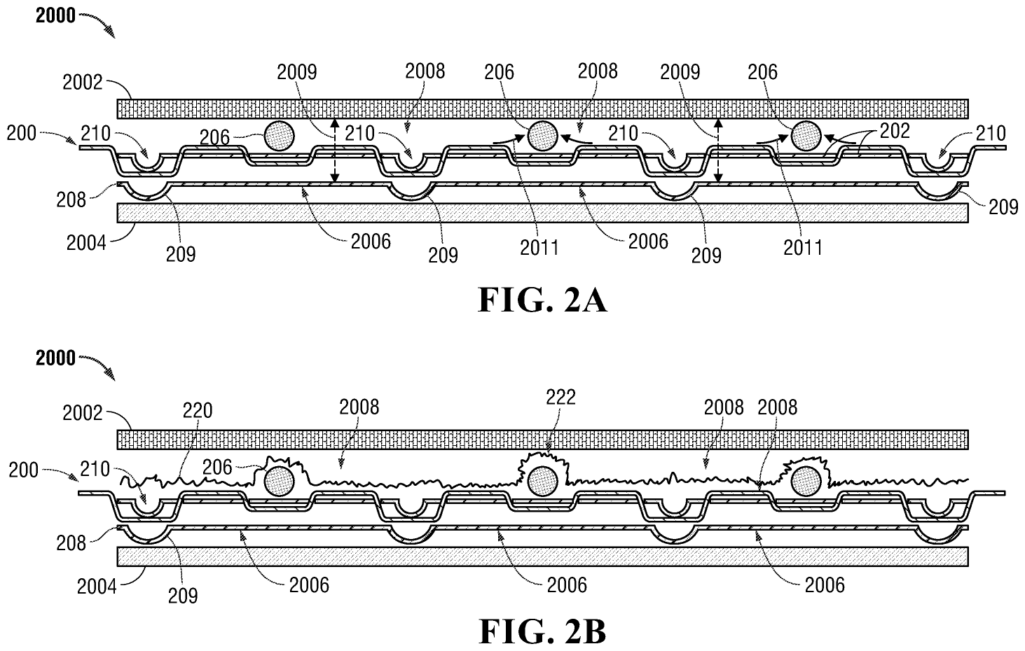

In FIG. 3B, the protective drainage wrap 300 is shaped such that channels 310 are formed on a front side of the protective drainage wrap 300. With reference to FIGS. 2A and 2B, as used herein the “front” or “frontside” refers to the side or surface of the protective drainage wrap that faces the siding and environment exterior to a structure when installed in the structure, and the “back” or “backside” refers to the side or surface of the protective drainage wrap that faces the sheathing and interior of the structure when installed in the structure. Additionally, describing a first element as being “frontward” of a second element indicates that the first element is positioned closer to the front of the protective drainage wrap and siding and exterior environment than the second element. Also, describing a first element as being “backward” of a second element indicates that the first element is positioned closer to the back of the protective drainage wrap and sheathing and structure than the second element.

In some embodiments, the shaping of the protective drainage wraps disclosed herein is achieved via embossing one or more material elements of the protective drainage wraps. For example, the CD tapes, the MD tapes, the base layer, or some combination thereof can be shaped (e.g., embossed). The channels 310 (or troughs) extend generally in the CD direction and generally parallel with the CD tapes 302. The channels 310 provide a path along which gravity-driven fluid can flow within the protective drainage wrap 300. As illustrated, every fourth CD tape 302 is embossed to form a channel 310. However, any number of the CD tapes 302 can include an embossed channel, and the channels can be evenly spaced (as shown) or unevenly spaced. While not shown, in some embodiments, at least some of the MD tapes can be embossed to form channels. The channels 310 are intermediate the yarns 306. However, in some embodiments, the channels can be coincident with the yarns, or both intermediate of and coincident with the yarns. While not shown in the cross-directional views of FIGS. 3B and 3C, at some MD cross-sections, the MD tape weaves over the yarn 306.

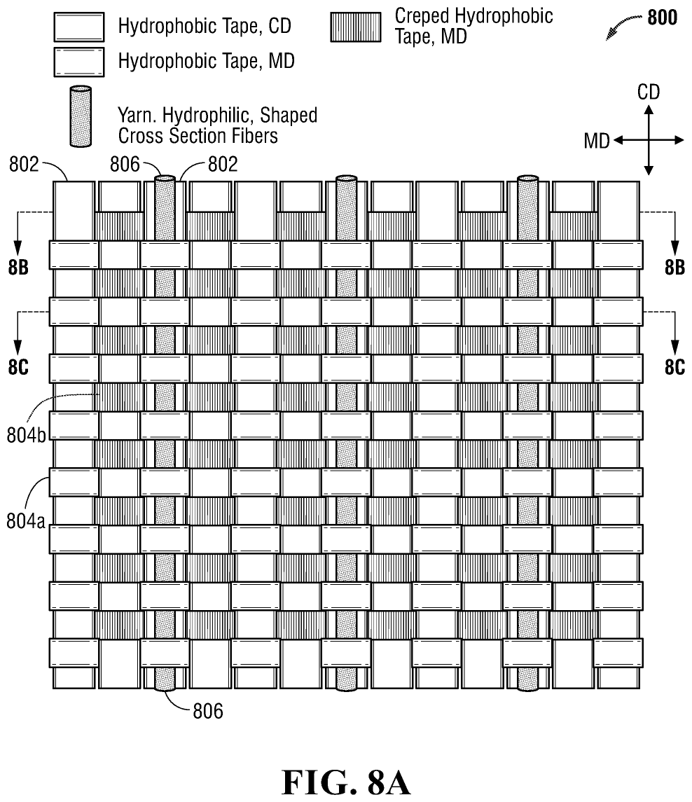

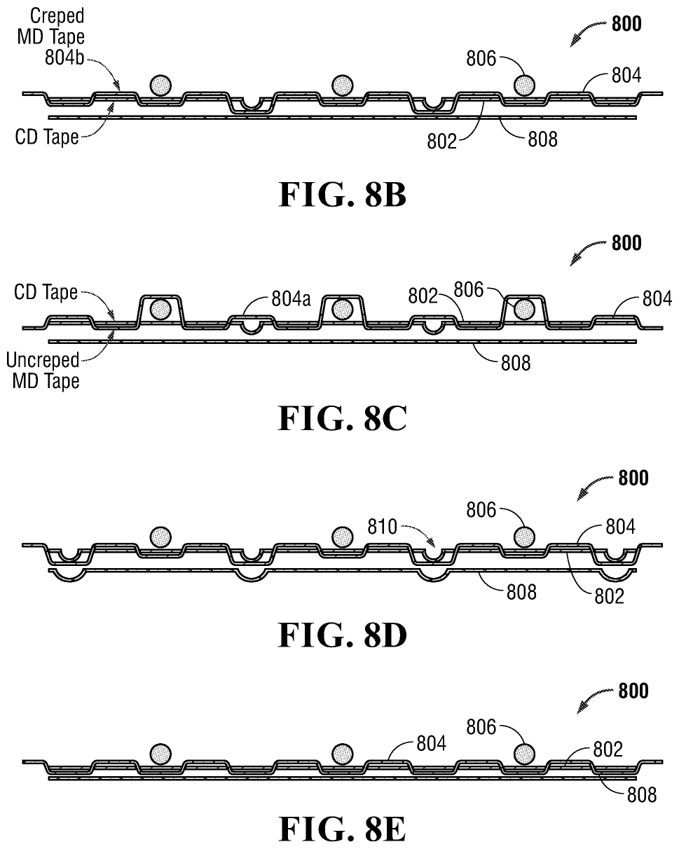

The channels 310 can increase the volume of liquid that can be drained by the protective drainage wrap 300. In some embodiments, the channels 310 provide a passage for air flow to increase the amount of air drying of liquid on the protective drainage wrap 300. Air drying can be useful for drying liquid that does not accumulate sufficiently to flow. Embossed channels in the MD direction can increase the flow of liquid across the protective drainage wrap to the channels that extend in the CD direction and/or to the yarns. The embossing can be performed before or after the CD and MD tapes are woven together, and before or after the base layer is coupled with the cross-woven base web. In embodiments where the CD tapes are embossed after being woven with the MD tapes, then at least some portion of the MD tapes that overlap the embossed CD tapes will also be embossed. FIG. 3C depicts an alternative embodiment of the protective drainage wrap that does not include embossed channels. For example, for reference see the cross-sectional view in FIG. 8C which shows a weave pattern of a similar, although not identical, MD tape 804.

The CD and MD tapes disclosed herein can be made of the same or different materials. In some embodiments, all of the MD and CD tapes are made of a first material. In other embodiments, all of the CD tapes are made of a first material and all of the MD tapes are made of a second material that is different than the first material. Additionally, all the CD tapes disclosed herein can be made of the same material, or the plurality of CD tapes can include multiple different CD tapes made of different materials. Similarly, all the MD tapes disclosed herein can be made of the same material, or the plurality of MD tapes can include multiple different MD tapes made of different materials.

In some embodiments, the CD and MD tapes include a hydrophobic material. In some embodiments, the CD and MD tapes include a hydrophilic material. In some embodiments, the CD and/or MD tapes include some tapes of a hydrophobic material and some tapes of a hydrophilic material. The CD and MD tapes can be polymeric, and can include polyolefins, polyesters, nylons, ethylene vinyl alcohol, or combinations thereof. Some exemplary polyolefins that can be used in forming the CD and MD tapes include polypropylene or polyethylene.

The polypropylene can be a homopolymer or a polypropylene copolymer, such as a copolymer of propylene with other aliphatic polyolefins, such as ethylene, 1-butene, 1-pentene, 3-methyl-1-butene, 4-methyl-1-pentene, 4-methyl-1-hexene, 5-methyl-1-hexene, or mixtures thereof. In some embodiments, the copolymers disclosed herein include at least 50 mole percent of propylene units with the minor proportion, in mole percent, including other monomers that are copolymerizable with propylene. In some embodiments, the copolymers disclosed herein include 50 percent by weight of propylene monomer units with the minor proportion, in weight percent, including other monomers that are copolymerizable with propylene

The polyethylene disclosed herein can be a homopolymer or a copolymer. Some examples of polyethylene suitable for use herein are low density polyethylene (LDPE), medium density polyethylene (MDPE), high density polyethylene (HDPE), very low density polyethylene (VLDPE), linear low density polyethylene (L LDPE), and metallocene-catalyzed linear low density polyethylene (mLLDPE). The polyethylene can be a copolymer of ethylene with other aliphatic polyolefins.

The polyesters disclosed herein can include a polyester resin that is a polycondensation product of a dicarboxylic acid with a dihydroxy alcohol. The polymer disclosed herein can be or include a polyethylene terephthalate that includes a polyester resin made from ethylene glycol and terephthalic acid. The polymer disclosed herein can be or include a nylon that is a polyamide polymer characterized by the presence of an amide group (—CONH).

Ethylene-vinyl alcohol (EVOH) is a thermoplastic copolymer of ethylene and vinyl alcohol. In commercial EVOH resins, the vinyl alcohol content typically various between about 55 and 75 mole percent EVOH can function as a smart vapor retarder due to its property of increased water vapor permeance with relative humidity.

In some embodiments, the polymer of the CD and MD tapes disclosed herein can include melt additives. In some embodiments, the polymer of the CD and MD tapes is or includes a smart vapor retarder film, such as when the tape is a hydrophilic tape. In some embodiments, the polymers of the CD and MD tapes are copolymers that are configured to have a desired wettability and hydrophilicity.

### Shaped Fibers

In some embodiments, the yarns disclosed herein a made of fibers that have a cross-sectional shape or profile that is configured to provide capillary voids between the fibers, configured to provide compressive strength to the yarn, or combinations thereof. For example, the fibers can be shaped such that the fibers have a non-circular cross-section. Such fibers with a non-circular cross-section can include one or more protrusions that extend outward from a center of the fiber. In some embodiments, the fibers with a non-circular cross-section are multilobal, such as bilobal, trilobal, tetra-lobal, quadralobal, penta-lobal, hexa-lobal, hectalobal, or octolobal. The cross-sections of such multilobal fibers include multiple separate lobed portions that extending from a centrally located portion of the fiber. When such non-circular cross-sectional fibers are packed together in a yarn, void spaces exits between the fibers that serve as capillary tubes or pores within the yarn. Thus, the shaped fibers can increase the capillarity of the yarns and increase the bulkiness of the yarn. Additionally, fibers with a non-circular cross-section have more surface area in comparison to an otherwise identical fiber that has a circular cross-section. The additional surface area of the fibers increases the ability of the fibers to wick and transport (via capillary action) more liquid. The surface areas of fibers with a non-circular cross-section, relative to an otherwise equivalent circular fiber, is higher and increases with the number of lobes. The surface area increase of the fibers with a non-circular cross-section can be estimated from the ratio of fiber perimeter of the shaped fiber relative to the perimeter of an otherwise equivalent fiber with a circular cross-section. For example, the surface area of the fibers with a non-circular cross-section can be from 1.1 to 3 or 1.3 to 1.7 times greater than an otherwise equivalent fiber with a circular cross-section. The increase in surface area is not limited to these exemplary ranges, and can be more or less depending on the particular fiber.

Yarns of fibers with a non-circular cross-section have increase compressive strength relative to otherwise identical yarns of fibers with circular cross-sections. The fibers disclosed herein can be synthetic polymer fibers made by extrusion of a molten polymer from a die that is shaped to provide the fibers with the desired non-circular cross-section. The fibers can be continuous fibers or substantially continuous along the extent of the yarn.

Thus, the fibers have a non-circular shaped cross section that maximizes the pore volume of the yarn, and maximizes the bulk and compressive resistance of the yarn. The higher pore volume of the yarn provides for increased drainage of liquid through the yarn. The higher bulk of the fibers provides for larger fiber protrusions, resulting in more air volume in the yarn for increased drainage and air drying. The higher compressive resistance of the yarn and fibers allows the yarn and fibers to avoid compression and, thereby, persevere the increased space and pore volume.

The multilobal fibers have individual wicking channels that increase with number of lobes. When bundled into a yarn structure, some advantages provided by multilobal fibers include higher inter-fiber pore volume and bulk and compressional resistance, which provides increased liquid transport for enhanced drainage and enhances the ability of the yarn to act as a spacer when the protective drainage wrap is installed on a structure.

In some embodiments, the yarn thickness (denier) is selected to provide a desired protrusion height of the yarn from the frontside of the cross-woven base web. For example, the yarn can have a thickness (denier) ranging from 0.7 mm to 4 mm, or from 1 to 3, or preferably 2 mm.

FIG. 3D(I) depicts a yarn 306 and two alternative cross-sectional views (II and III) of a yarn showing the cross section of fibers of the yarn 306. The yarn 306 can be a hydrophilic yarn that provides an elongated capillary-driven conduit for water in the protective drainage wraps disclosed herein. The yarn 306 can be made of a plurality of continuous fibers 312 or 314 having cross-sections that are shaped to provide desired properties (e.g., capillarity and compressive strength). Suitable fibers 312 are octolobal, and suitable fibers 314 are trilobal. In a yarn of such multi-lobal fibers, interstitial space 316 is positioned between adjacent fibers. The interstitial space 316 between the fibers forms channels, tubes or pores that induce and/or facilitate capillary-driven and/or gravity-driven fluid flow downwardly (drainage direction) through the yarn to a lower edge of the protective drainage wrap and away from the underlying building surfaces. In addition, the fibers 312 or 314 of the yarn 306 can be made of a material that is hydrophilic. FIG. 3D (IV) shows a collection of other exemplary fibers having a non-circular cross section, including fiber 360 having an oval or ovoid cross-section, fiber 362 having a quadrilobal cross-section, and fiber 364 having a pentalobal cross-section. The yarns disclosed herein are not limited to fibers with these particular cross-sections, and can include other multi-lobal fibers or other fibers having a non-circular cross-sections. The fibers having a non-circular cross-sections can have regular, symmetrical cross-sections, or irregular, asymmetrical cross-sections.

In some embodiments, the cross-section of the fibers have an aspect ratio that is not 1:1, such as an aspect ratio of greater than 1:5. In some embodiments, the cross-section of the fibers having a non-circular cross-section has a shape factor of greater than 1. As would be understood by one skilled in the art, the shape factor is the ratio of the perimeter of the cross-section of the non-circular fiber to the circumference of the equivalent area of an otherwise identical fiber having a circular cross-section.

### Protective Wraps with Hydrophile CD Tape

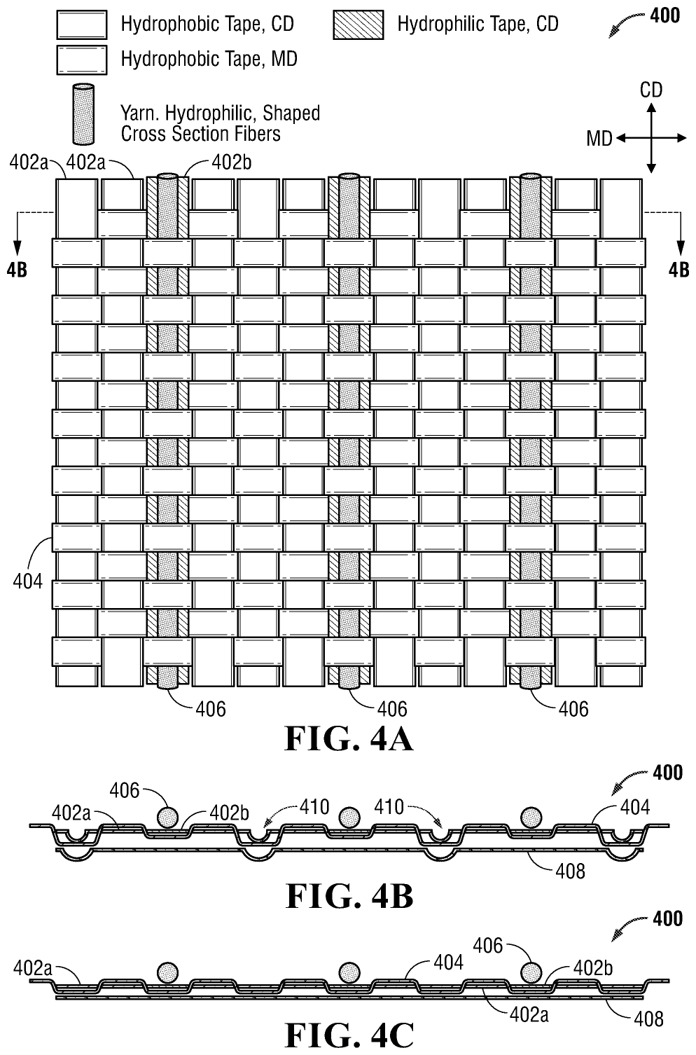

In some embodiments, one or more of the tapes of the protective drainage wraps can be hydrophilic. With reference to the protective drainage wrap 400 of FIGS. 4A-4C, a first portion of the CD tapes 402a are hydrophobic and a second portion of the CD tapes 402b are hydrophilic. In particular, the CD tapes 402b that are positioned beneath the yarns 406 are hydrophilic, with the remaining CD tapes 402a and the MD tapes 404 being hydrophobic. Positioning hydrophilic CD tapes 402b beneath the yarns 406 can increase the amount of water on the web of the protective drainage wrap 400 that is drawn to the yarn 406; thereby, increasing the amount of water the yarn 406 is able to wick away from the remainder of the web of the protective drainage wrap 400. The hydrophilic CD tape 402b can act as a funnel that directs or draws liquid to the yarn 406. In some embodiments, the yarn 406 is more hydrophilic than the hydrophilic CD tape 402b such that liquid more readily flows from the hydrophilic CD tape 402b to the yarn 406. The CD tape 402b supporting the yarn 406 can facilitate the preservation of the structural integrity of the underlying barrier layer 408 and reduce the probability of liquid water intrusion there-through.

As shown in FIG. 4B the protective drainage wrap 400 can be shaped (e.g., embossed) to form channels 410 as described above in reference to FIG. 3B. Alternatively, embodiments of the protective drainage wrap 400 may not be embossed, as shown in FIG. 4C. In some embodiments, the embossed tape that forms the channels 410 is hydrophobic, as a hydrophobic surface facilitates the formation and maintenance of water in the form of droplets for the purposes of drainage and air drying. The droplet shape of the water in the channels 410 can, in turn, cause the water to flow more readily on the surface of the channels 410. The channels 410 can be positioned in areas where the yarn 406 is not positioned to wick away moisture, such as in the gaps between the yarns 406. Thus, the embodiment of FIGS. 4A and 4B combines the use of hydrophilic CD tape 402b at, under, or near the yarn 406 with the use of hydrophobic CD tape 402a in areas that are not under the yarn 406; thereby, increasing water drainage properties of the protective drainage wrap 400. As shown in FIGS. 4B and 4C, respectively, the barrier layer 408 can be embossed or not embossed. FIG. 4B is a simplified at least partially exploded view showing the barrier layer 408 spaced apart from the base web; however, the barrier layer may be laminated directly onto the base web.

### Gradient Hydrophilcity

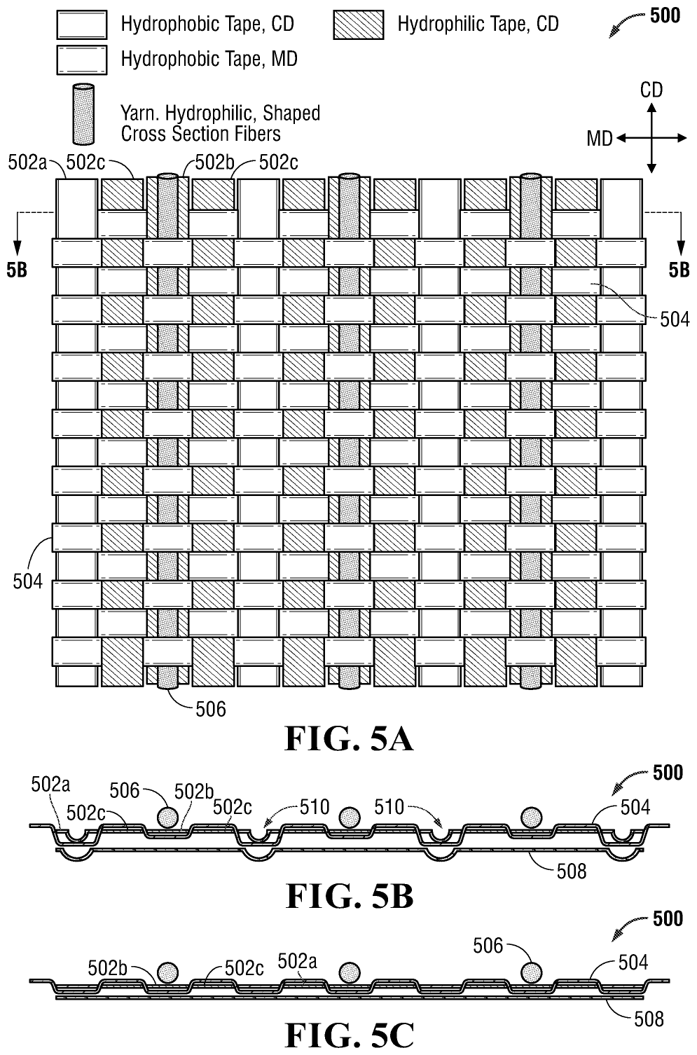

In some embodiments, the CD tapes both beneath and adjacent the yarn are hydrophilic. With reference to FIGS. 5A-5C, protective drainage wrap 500 includes a first portion of the CD tapes 502a that are hydrophobic, a second portion of the CD tapes 402b that are hydrophilic and positioned beneath the yarn 506, and a third portion of CD tapes 402c that are hydrophilic and positioned adjacent the CD tapes 402b and adjacent the yarns 506 (i.e., between the CD tapes 402a and 402b. The MD tapes 504 in this embodiment are hydrophobic.

The additional hydrophilic CD tapes 502c (relative to the embodiment shown in FIG. 4A) can attract additional liquid to and adjacent the CD tapes 502b and, thereby, the yarn 506, where the liquid can then be wicked away by the yarn 506. The use of additional hydrophilic CD tapes 502c can increase the surface area that attracts liquid to the yarn 506. In some embodiments, the level of hydrophilicity can be varied between the various CD tapes 502b and 502c and the yarn 506. For example, the CD tape 502b, beneath the yarn 506, can be more hydrophilic than the CD tape 502c adjacent the yarn 506, and the yarn 506 can be more hydrophilic than the CD tape 502b. In such a configuration, the liquid can be encouraged to flow from the less hydrophilic CD tape 502c to the more hydrophilic CD tape 502b, and then to the yarn 506. In the embodiment depicted in FIG. 5B, the CD tape 502a that is embossed to form channels 510 is hydrophobic to maintain flow of liquid along the surface of the channels 510. The barrier layer 508 can be embossed as shown in FIG. 5B, or not embossed as shown in FIG. 5C. FIG. 5B is a simplified at least partially exploded view showing the barrier layer 508 spaced apart from the base web; however, the barrier layer may be laminated directly onto the base web.

### Hydrophilic Yarns Positioned in Embossed Channels

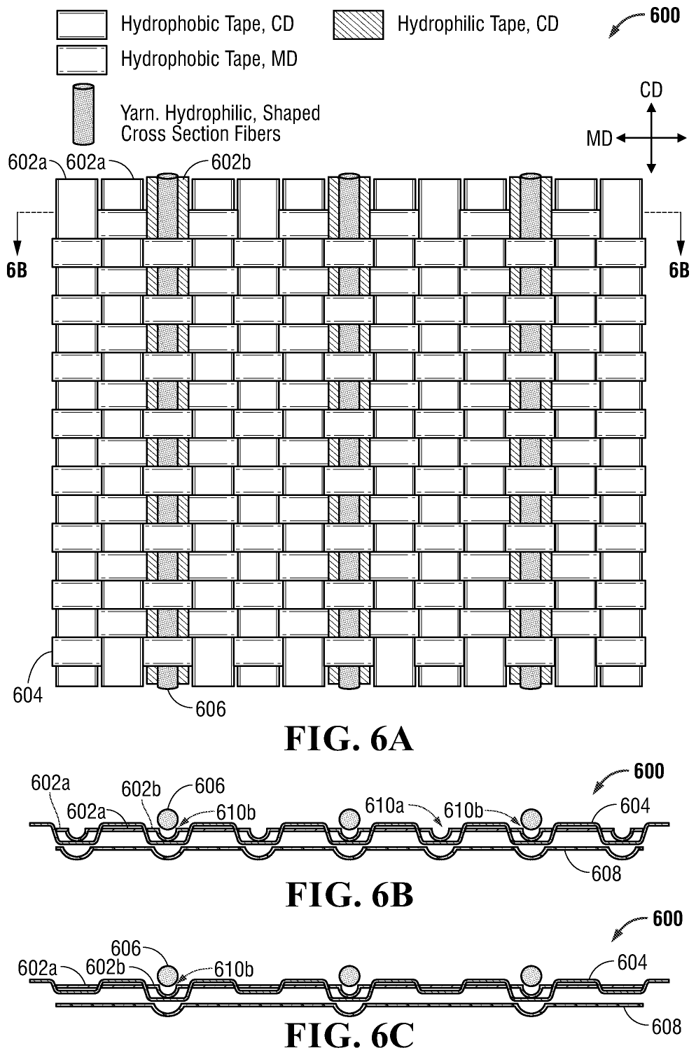

In some embodiments, the CD tape that is positioned beneath the yarn is shaped (e.g., embossed) to have a channel or trough and the yarn is positioned within the channel. With reference to FIGS. 6A-6C, protective drainage wrap 600 is embossed to form channels 610a and 610b. The yarns 606 are positioned within the channels 610b, and the channels 610a are empty (i.e., do not have yarn positioned therein). The CD tape 602b that forms the channels 610b is hydrophilic, and the remaining CD tape 602a, including the CD tape that forms the channels 610a, is hydrophobic. The embossed shape of the CD tape 602b provides a flow path of liquid toward the yarn 606 that is based on the shape of the yarn. The embossed CD tape beneath the yarn can be hydrophilic or hydrophobic, as the shape of the embossed tape is used to draw liquid toward the yarn, regardless of whether the embossed tape is hydrophilic or hydrophobic. As with the prior described embodiments, the MD tape 604 is hydrophobic, and the barrier layer 608 is a breathable, solid coating layer that is embossed. FIG. 6C is an alternative embodiment that includes only the channels 610b, and does not include the channels 610a between the yarn 606. FIGS. 6B and 6C are simplified at least partially exploded views showing the barrier layer 608 spaced apart from the base web; however, the barrier layer may be laminated directly onto the base web.

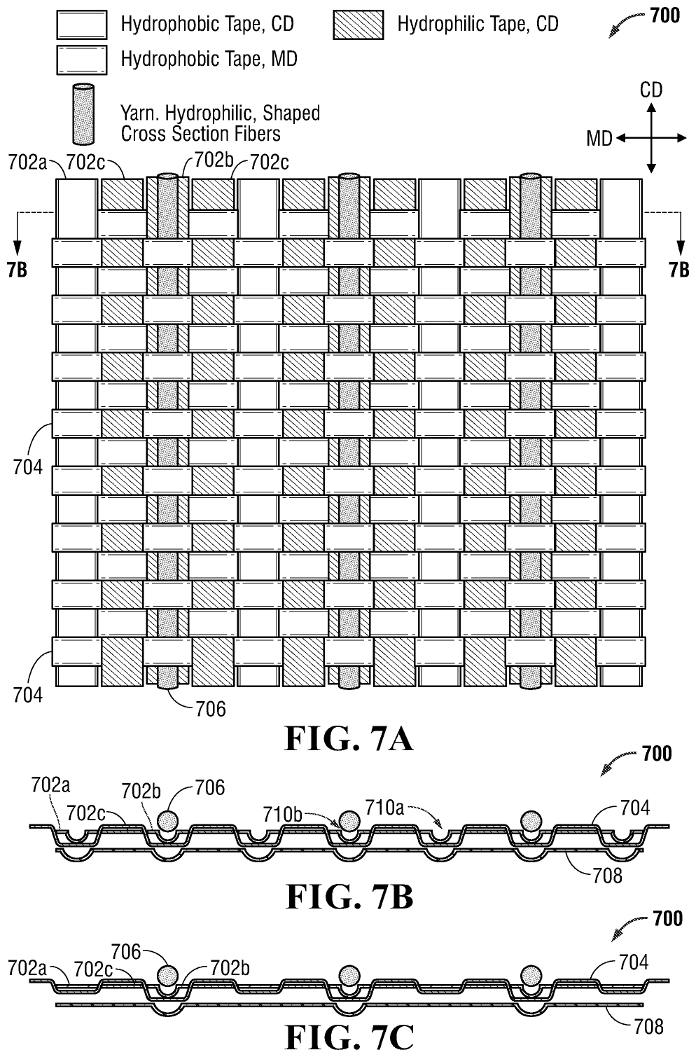

FIGS. 7A-7C depict an embodiment similar to FIGS. 5A-5C, but with the addition of the yarn being positioned in, on, or within embossed channels. Protective drainage wrap 700 includes a first portion of the CD tapes 702a that are hydrophobic, a second portion of the CD tapes 702b that are hydrophilic and positioned beneath the yarn 706, and a third portion of CD tapes 702c that are hydrophilic and positioned adjacent the CD tapes 702b and adjacent the yarns 706. The MD tapes 704 are hydrophobic. The protective drainage wrap 700 is embossed to form channels 710a and 710b. The yarns 706 can be positioned within the channels 710b, and the channels 710a can be empty. The CD tape 702b that forms the channels 710b is hydrophilic, the CD tape 702c that adjacent the channels 710b are hydrophilic, and the CD tape 702a form the channels 710a are hydrophobic. As with the prior described embodiments, the MD tape 704 can be hydrophobic, and the breathable, solid coating layer 708 can be embossed. FIG. 7C is an alternative embodiment that includes only the channels 710b, and does not include the channels 710a between the yarn 706. FIGS. 7B and 7C are simplified at least partially exploded views showing the barrier layer 708 spaced apart from the base web; however, the barrier layer may be laminated directly onto the base web.

### Materials with a Three-Dimensional Topography

In some embodiments, one or more of the materials of the protective drainage wraps have a three-dimensional topography that is configured to increase the surface area of the material, promote gravity-driven drainage, promote air drying, or combinations thereof. The three-dimensional topography can be achieved via embossing as described above or creping, for example. For example, the MD tapes and/or CD tapes can be shaped to have a three-dimensional topography.

FIGS. 8A-8C depict an embodiment of a protective drainage wrap with MD tapes having a three-dimensional topography (e.g., creped tapes). While shown as creped tapes, the three-dimensional topography is not limited to being in the form of creping. The three-dimensional topography can present an undulating surface with spaced apart ridges and valleys. The three-dimensional topography cam be formed by creping, folding, gouging, or another method. Protective drainage wrap 800 includes CD tapes 802 that are hydrophobic, a first portion of MD tapes 804a that are hydrophobic, and a second portion of MD tapes 804b that are hydrophobic and creped. The protective drainage wrap 800, including the barrier layer 808, can be embossed to form channels 810 in the drainage direction as shown in FIG. 8B, or not embossed as shown in FIG. 8C. While the CD tapes 802 are hydrophobic, in some embodiments the CD tapes are hydrophilic, and, preferably, the CD tapes 802 below the yarns 806 are hydrophilic.

The yarns 806 are positioned between the channels 810. As shown in FIG. 8A, the MD tapes 804a are weaved above the yarns 806, and the MD tapes 804b are weaved beneath the yarns 806.

The creping of the MD tapes 804b provides a physical structure to the MD tapes 804b such that the surface of the MD tapes 804b includes a ridged or corrugated or undulated profile with ridges and valleys. The creping can include pushing together the surface of a tape until the tape buckles, forming the ridges and valleys. The ridges and valleys of the MD tapes 804b extend in a direction that is orthogonal to the direction that the MD tapes 804b extend. In FIG. 8A, the MD tapes 804b extend in the MD direction, and the ridges and valleys, thus, extend in the CD direction. As such, the MD tapes 804b provide channels (i.e., the valleys) along which liquid is encouraged to flow; thereby, increasing the flow rate of liquid along the protective drainage wrap 800.

The creping of the MD tapes 804b can also provide for the passage of air to increase the amount of air drying of liquid, such as for drying liquid that does not accumulate sufficiently to flow. The number of crepes per unit length and the depth (i.e., the height difference between adjacent ridges and valleys) of the creping can be adjusted as desired. In the embodiment shown in FIG. 8A, the MD tapes alternate between creped MD tapes 804b and MD tapes 804a that are not creped. However, the number and pattern of creping can be varied. The creped MD tapes 804b may be more subject to stretching and elongating relative to the MD tapes 804a that are not creped. In embodiments with both creped MD tapes 804b and MD tapes 804a that are not creped, the creped MD tapes 804b provide the drainage and air-drying benefits described above and the MD tapes 804a that are not creped provide tensile strength to the cross-woven base web in the MD direction. Thus, the MD tapes 804a prevent the stretching and elongation in the MD direction that may occur if all of the MD directed tapes were creped. In some embodiments, the creped MD tapes 804b are creped tapes having a crepe height that is less than the thickness of the yarn, such as from about 1 to about 2 mm, plus or minus 10%. The creped MD tapes 804b can exhibit a percent of crepe of from 5 to 75%, or 10 to 65%, or 25-50%, or any range or discrete value therebetween.

FIGS. 8B-8D are simplified at least partially exploded views showing the barrier layer 808 spaced apart from the base web; however, the barrier layer may be laminated directly onto the base web.

### Multi-Layer Construction with Three-Dimensional Topography

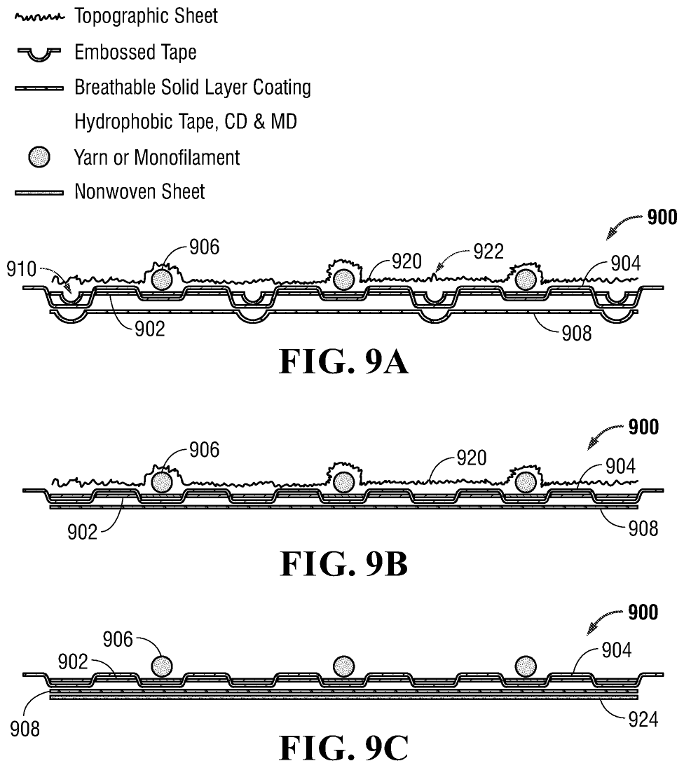

With reference to FIGS. 9A-9C, some embodiments include a barrier protection system that has a multi-component and/or multi-layered construction incorporating the cross-woven base web or fabric and a top layer, an additional barrier layer, or combinations thereof.

FIG. 9A depicts an embodiment of protective drainage wrap 900 including a barrier layer 908 that is a breathable, solid coating layer as a backing beneath (i.e., on a backside) of the cross-woven base web, CD tape 902 on the barrier layer 908 and embossed to form channels 910, yarns 906 supported on hydrophobic CD tape 902, and a top layer 920.

The top layer 920 has a three-dimensional topography. In the embodiment of FIG. 9A, top layer 920 is a creped fabric, such as a creped spunbond or creped film or embossed spunbond. The creped top layer 920 has channels 922 that are directed in the CD direction that provide increased drainage volume to promote enhanced drainage and provide higher surface area for enhanced air drying. In some embodiments, the creped top layer 920 provides thermal insulative properties to the protective drainage wrap 900. Thus, the top layer 920 is provided with a textured surface that imparts or exhibits a desired 3-D topography. Embossed spunbond or nonwoven can also achieve the desired 3-D topography, such as by employing certain bond patterns to create desired directional drainage surface tendencies. The 3-D topography results in increased surface area for the top layer 920 (with the same base web footprint), as would be evident if the 3-D surface were stretched and flattened to expose the extended surface of the facing layer. Such an increased surface area also provides an extended surface for moisture to collect or set; thereby, facilitating air drying. Additionally, the increased thickness and space created by the 3-D topography presents thermal insulative properties—presenting both increased air space and solid media as additional layers of insulation (i.e., heat transfer media). In some embodiments, the top layer 920 is a creped film or spunbond having a crepe height that is less than the thickness of the yarn 906, such as from about 1 to about 2 mm, plus or minus 10%. The top layer 920 can exhibit a percent of crepe of from 5 to 75%, or 10 to 65%, or 25-50%, or any range or discrete value therebetween.

As shown in the cross-sectional views, the 3-D surface presents troughs 922 and valleys directed in the CD direction, which function as drainage channels. Even if the troughs 922 do not extend continuously and uninterrupted to the bottom edge of the protective drainage wrap 900, the surface can provide a concentration or collection of channels and mini-channels that present a network of channels, collectively passing fluid flow in the CD direction. Additionally, the 3-D topography of the creping provides for increased thickness and space

The protective drainage wrap 900 also includes MD tape (not shown). In the embodiment of FIG. 9A, the yarn 906 is positioned between the top layer 920 and at least some of the CD tapes 902. Thus, the embodiment shown in FIG. 9A is a tri-layer laminate, including a first layer that is the barrier layer 908, a second layer that is the cross-woven base web formed of the yarn 906 and MD and CD tapes 902, and a third layer that is the top layer 920.

The protective drainage wrap 900 of FIG. 9A is shaped to include embossed channels 910. When installed between sheathing and siding, the embossed channels 910 can provide space between adjacent portions of the barrier layer 908 and the sheathing that promotes air drying of the protective drainage wrap 900.

The embodiment depicted in FIG. 9A also features a material barrier protection system employing channels 910 in the CD direction in correspondence with the troughs 922 in the top layer 920. The channels 910 may be created by an embossing process directed at selected tape elements in the CD direction. Such embossing may occur before weaving, during weaving, or after weaving. The channels 910 and troughs 922 increase the drainage capacity of the wrap and increase the surface area available for water exposure or collection, which facilitates air drying.

The embodiment of FIG. 9B is substantially identical to that of FIG. 9A with the exception that the protective drainage wrap 900 in FIG. 9B does not include any embossing. FIG. 9A is a simplified at least partially exploded view showing the barrier layer 908 spaced apart from the base web; however, the barrier layer may be laminated directly onto the base web.

### Nonwoven Sheet

Some embodiments include a material layer positioned on the barrier layer such that the barrier layer is positioned between the material layer and the cross-woven base web. As such, when installed, the material layer is engaged with the sheathing of the structure. The embodiment shown in FIG. 9C includes a material layer, nonwoven sheet 924, positioned beneath the barrier layer 908. The nonwoven sheet 924 can provide additional protection from moisture and heat to the underlying structure, and can provide protection to the barrier layer 908. For example, the nonwoven sheet 924 can protect the barrier layer 908 from mechanical (e.g., abrasion) damage, such as preventing rupture or tear of the barrier layer 908 during manufacturing, handling, and/or installation.

In addition to providing protection from physical damage to the barrier layer 908, the presence of the nonwoven sheet 924 reduces the strength requirements for the barrier layer 908. For example, a barrier layer 908 of a lower basis weight and/or a thinner barrier layer 908 can be used with the nonwoven sheet 924 in comparison to the basis weight and/or thickness that would be required if the nonwoven sheet 924 were not present. For example, relatively thicker barrier layers are typically recommended in order to protect against damage to the barrier layer, such as from handling or installation. However, the protection of the nonwoven sheet 924 allows for a relatively thinner barrier layer to be used. The use of thinner barrier layers increases the breathability (vapor permeability) of the barrier layer. While the embodiment shown in FIG. 9C lacks the top layer shown in FIGS. 9A and 9B, in some embodiments a top layer and a bottom material layer can be combined in a multilayer laminate construction.

When installed, the presence of the nonwoven sheet 924 results in the barrier layer 908 being spaced-apart or gapped from the underlying sheathing. The nonwoven sheet 924 can be an open fibrous network of polymeric fibers, such that the nonwoven sheet 924 has void space therein. The additional space or gap between the barrier layer 908 and the sheathing, combined with the additional void space within the nonwoven sheet 924, protects the underlying sheathing from moisture contact and provides for enhanced air drying, such as during humid conditions.

One particular embodiment of a multilayer laminate construction is a tri-layer protective drainage wrap that includes a cross-woven base web (bases weight 55 gsm) with a monolithic breathable barrier layer (basis weight 20-22 gsm) on a bottom surface thereof and a spunbond top layer (basis weight 10 gsm) on a front side of the cross-woven base web. In some embodiments, the basis weight of the tri-layer protective drainage wrap is from 45 to 300 gsm, or from 100 to 250 gsm, or from 150 to 200 gsm, such as 135 gsm. In some embodiments, the basis weight of the cross-woven base web is from 30 to 200 gsm, or from 50 to 150 gsm, or from 75 to 125 gsm, or preferably from 50 to 75 gsm. In some embodiments, the basis weight of the barrier layer is from 5 to 75 gsm, or from 15 to 65 gsm, or from 25 to 55 gsm, or preferably from 20 to 30 gsm. In some embodiments, the basis weight of the nonwoven sheet (bottom material layer) is from 8 to 100 gsm, or from 20 to 80 gsm, or from 30 to 70 gsm, or from 40 to 60 gsm, or preferably from 10 to 15 gsm. The breathable barrier layer and the spunbond nonwoven sheet can be laminated together and/or to the cross-woven base web using an adhesive, for example.

### Protective Wraps with Hydrophilic MD Tape

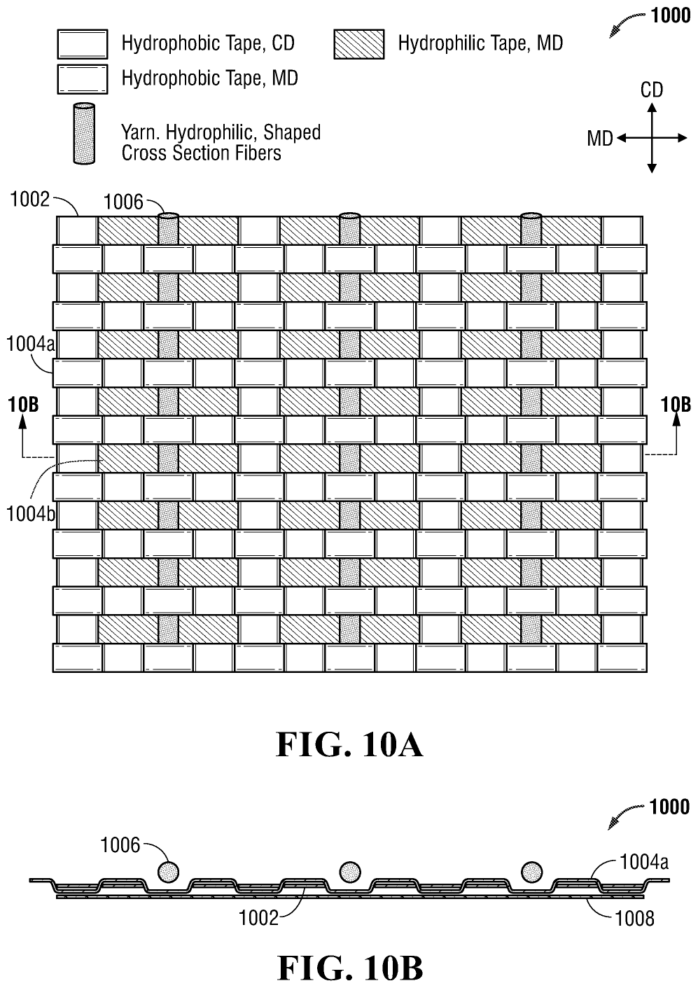

In some embodiments, the protective drainage wraps include hydrophilic MD tapes. With reference to FIGS. 10A and 10B, protective drainage wrap 1000 includes hydrophobic CD tape 1002, a first portion of hydrophobic MD tape 1004a, a second portion of hydrophilic MD tape 1004b, yarn 1006, and a barrier layer 1008. The hydrophilic MD tapes 1004b can facilitate the spread of liquid in the MD direction towards the yarns 1006. That is, liquid water between the yarns can be transported via the hydrophilic MD tapes 1004b to the yarns 1006.

In the embodiment of FIG. 10A, the base web does not include a CD tape situated beneath the length of the yarn 1006. In more preferred embodiments, such a CD tape is installed and may be placed beneath yarn across the entire base web such that the yarn is placed above the CD tape material and protected thereby across the entire CD length of the base web. In this way, proximity between the hydrophilic MD tapes and the yarn in FIG. 10A is maintained. Most preferably, the CD tape is interwoven or interlaced with the base web, including the MD tapes and, as necessary, provided with hydrophilic sections which are then located adjacent the yarn and/or the CD tape is made entirely hydrophilic material.

### Protective Drainage Wrap Installation

With reference to FIG. 2A, the installation of one exemplary protective drainage wrap in a building is depicted. Building 2000 includes sheathing 2004 and siding 2002 (e.g., brick). Protective drainage wrap 200 is installed between the sheathing 2004 and siding 2002. For example, the protective drainage wrap 200 can be stapled, nailed, screwed, or otherwise fastened or adhered to the sheathing 2004, and the siding 2002 can then be installed over the protective drainage wrap 200.

The protective drainage wrap 200 is the same as or substantially similar to the protective drainage wrap shown in FIG. 3B. The protective drainage wrap 200 includes base layer 208, CD tapes 202, MD tapes (not shown), and yarn 206. In the embodiment depicted in FIG. 2A, the protective drainage wrap 200 is embossed such that the base layer 208 includes troughs 209 that define channels 210. When installed, the presence of the troughs 209 in the base layer 208 results in the raising of portions of the base layer 208 away from the underlying sheathing 2004. Thus, the troughs 209 provide for backside air gaps 2006 (or air channels) between portions of the base layer 208 and the underlying sheathing 2004. These air gaps 2006 facilitate air drying and also keep portions of the base layer 208 spaced-apart from the sheathing 2004, further protecting the building from moisture.

On the front side of the protective drainage wrap 200, i.e., the side facing the siding 2002, the protective drainage wrap 200 includes yarns 206. The yarns 206 are capillary-driven drainage elements that draw water downward in a drainage direction. The channels 210 on the front side of the protective drainage wrap 200 provide flow paths for liquid that is not taken up by the yarns 206. The yarns 206 are at least partially raised above the CD tapes 202 and have a thickness that is sufficient to form a space between the siding 2002 and the CD tapes 202, providing front-side air gaps 2008. These air gaps 2008 facilitate air drying and keep portions of the protective drainage wrap 200 spaced-apart from the siding 2002.

FIG. 2A shows some of the vapor transmission paths 2009 through the wrap 200 as well as liquid wicking paths 2011 into the yarns 206. While these paths are not called out in FIG. 2B, the same or similar paths can be present in the embodiment of FIG. 2B. Furthermore, these paths are for exemplary purposes only and are not intended to be limiting.

With reference to FIG. 2B, the installation of another exemplary protective drainage wrap in a building is depicted. Building 2000 includes sheathing 2004 and siding 2002 (e.g., brick). Protective drainage wrap 200 is installed between the sheathing 2004 and siding 2002, and is substantially the same as that shown in FIG. 2A, but with the addition of the top layer 920 of nonwoven with the ridges 922 formed via creping. The yarns 206 are at least partially raised above the CD tapes 202 and of a thickness that is sufficient to form a space between the siding 2002 and the CD tapes 202, providing front-side air gaps 2008 between the top layer 222 and the siding 2002 and additional front-side air gaps 2008 between the top layer 222 and the CD tapes 202. These air gaps 2008 facilitate air drying and keep portions of the protective drainage wrap 200 spaced-apart from the siding 2002. FIGS. 2A and 2B are simplified at least partially exploded views showing the barrier layer 208 spaced apart from the base web; however, the barrier layer may be laminated directly onto the base web.

FIGS. 2A and 2B (and the cross-sectional illustrations of FIGS. 3A-10B) provide simplified illustrations showing the various components of described systems, and, to some degree, their physical relations and juxtapositions. The illustrations are not to scale and are not precise representations. For clarity and to facilitate descriptions, the components are sometime drawn, to a slight degree, in exaggerated fashion and/or exploded perspective. This is particularly true of relatively thin layers or close fit mutually-embossed components or layers in the various multi-layer constructions and embodiments described herein. (See e.g., FIGS. 3A, 4A, 5A, 6A, . . . ) The plan views of FIGS. 3A, 4A, 5A, 6A, 7A, 8A, and 10A are simplified illustrations showing the various components of described systems, and, to some degree, their physical relations and juxtapositions. The illustrations are not to scale and are not precise representations, and some features, such as troughs may not be viewable in such plan views.

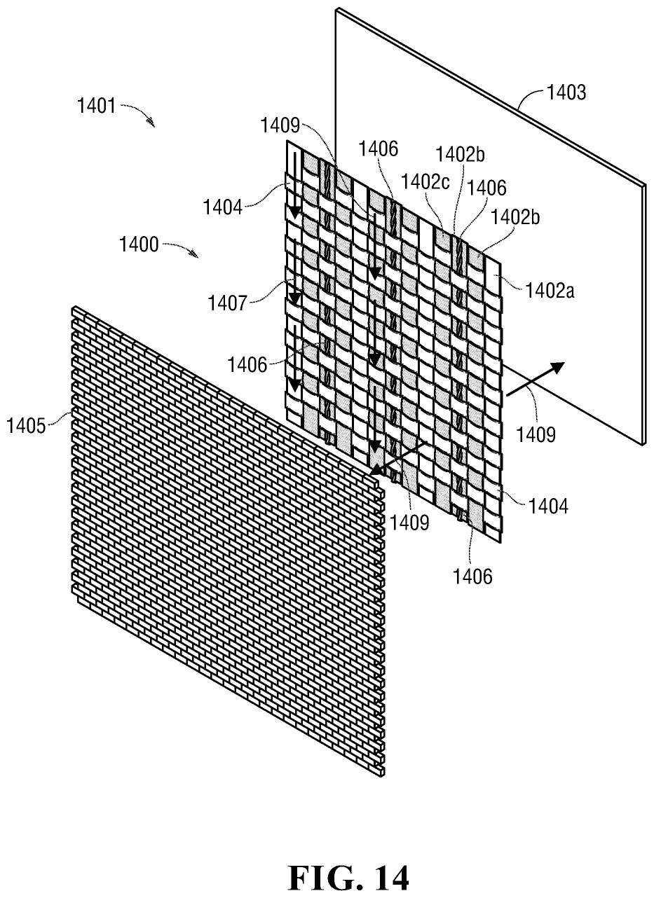

FIG. 14 is an exploded view of an installation. Installation 1401 includes sheathing 1403, siding 1405, and protective drainage wrap 1400. Protective drainage wrap 1400 is the same as or similar to the wrap shown in FIG. 5A. Wrap 1400 includes yarns 1406, hydrophobic MD tape 1404, hydrophobic CD tapes 1402a, hydrophilic CD tapes 1402b, and hydrophilic CD tapes 1402c. The yarns 1406 are more hydrophilic than the CD tapes 1402b, and the CD tapes 1402b are more hydrophilic than the CD tapes 1402c. The wrap 1400 is vapor permeable such that vapor 1409 passes therethrough. The wrap 1400 is liquid impermeable such that liquid water drains in a drainage direction 1404, such as via capillary action in yarns 1406.

### Additional Aspects and Variations

The present disclosure introduces certain and discrete features or improvements that may be incorporated, individually or in combination, into the barrier protection systems and/or the protective drainage wraps incorporating a basic interlaced web or fabric with advantageous affect. The additions or modification can achieve structural and performance benefits. To illustrate, the presently available drainage wrap known in the industry may readily adopt the following features or modifications: (1) use of a yarn with a higher modulus (maximize protrusion front and back of sheet); (2) use of yarn made of multi-lobal shaped fibers in the yarn for enhanced fluid flow and capillarity; (3) use of yarn supported on hydrophobic or hydrophilic CD tapes; (4) use of hydrophobic CD tapes, hydrophilic CD tapes or a combination thereof; (5) use of hydrophobic MD tapes, hydrophilic MD tapes or a combination thereof; (6) use of creped CD and/or MD tapes; (7) embossing CD and/or MD tapes to form channels; (8) supporting yarn between or within embossed channels; (9) use of CD tapes having gradient hydrophilicity; (10) use of a top layer of creped or embossed material for 3D topography; (11) use of a bottom layer of a nonwoven material; (11) modifying and/or selecting material or elements to present patterned wettability for enhanced drainage flow; (12) combining hydrophilic and hydrophobic elements for wettability control and water flow enhancement; (13) use of embossed troughs positioned to provide spacing between the wrap and an adjacent structure; (14) multi-laminate structures with a desired surface topography; or (15) combinations thereof.

In one aspect of the present disclosure, a material barrier systems, apparatus, or product is provided which incorporates a substantially continuous or contiguous fabric or blanket constructed of at least two sets of correlating members (MD and CD tapes) preferably adjoined in cross-relation. Such a construction of multiple structural elements exhibiting thickness and surface area may be referred to as a “web.” Typically, two sets of tapes or panels or boards structural members contributing to the surface area or make up of the web—are arranged along intersecting lines to make a network—the fabric or blanket. More preferably, the two tape members are disposed in transverse relation (e.g., perpendicular or generally perpendicular) and most preferably, adjoined as a cross-laminate or interlaced such as in a weave. See e.g. FIGS. 1-3 in 6 in U.S. Pat. No. 6,761,006 (which Figures and accompanying descriptions have been incorporated herein and made a part of the present disclosure). For purposes of the present description, such a construction may be referred to generally as a fabric or blanket, and is considered contiguous or continuous as when the cross-members are generally and relatively disposed to define a continuous or contiguous area or surface (of the web) within its perimeter that is, preferably, substantially or generally (but not necessarily, completely) free of voids, holes, gaps, or spaces between members.

In one aspect, such a material barrier systems, apparatus, or product a system or barrier is provided that incorporates cross-woven or cross-laminate materials as an integral layer, and, preferably, a layered portion comprising such cross-laminate or cross-woven materials.

In one aspect, the present disclosure presents a protective drainage wrap comprising a cross-woven base layer or fabric with a preferably breathable solid layer portion and characterized by enhanced drainage functionality. In one embodiment, the barrier protection system is equipped with oriented drainage channels and the system utilize capillarity-driven flow mechanisms in addition to gravity-driven flow in the traditional drainage regions. In one variation, the capillarity-driven drainage elements are elongated elements such as cords or yarns preferably comprised of hydrophilic, multi-lobal shaped fibers to accommodate higher fluid flows and compression resistance for maintaining overall drainage volume in the system. Furthermore, appropriate surface wettabilities may be provided to create paths to feed the wicking yarns

In another aspect, the present disclosure presents a barrier protection system, including a protective drainage wrap, having a three-dimensional structure, either one or two-sided. In preferred embodiments, three-dimensional features or characteristics of the system provides for and maintains the desired drainage volume. This volume also contributes to evaporative drying due to air circulation. Further, in these embodiments, the desired three-dimensional feature is created by the yarn and/or by surface topography, introduced by such mechanism as embossing, for example.

In another aspect, a material barrier construction is provided comprising a base web equipped with a drainage surface and, further, drainage channels for quickly passing water and moisture downward from the system and from building surfaces, inducing primarily by gravity-driven flow. In a further aspect, the material barrier construction is provided with elongated hydrophilic structural elements that act as conduit for passing water or moisture drawn into the structural element. In a further aspect, the structural element is a structural element incorporated into and made a part of the base web, and at least partly defines the cross-section of the web and the drainage surfaces of the system, while also presenting a conduit for capillary-driven and/or gravity-driven flow to add to and assist the system's drainage capabilities. The present disclosure further provides material selection and structural options (e.g., modifications) to enhance the conduit/structural elements drainage functionality (e.g., the wicking mechanism and capillary flow mechanism inherent in the structure).

In another aspect, a protective drainage wrap is provided having a multi-laminate structure (preferably tri-laminate). In one variation, the barrier protection system incorporates a top layer of sheet with topography of appropriately oriented drainage channels. The full sheet may be creped or embossed spunbond, nonwovens or film.

In another aspect, a material barrier construction is disclosed having a first portion comprising a fabric cross-woven or cross-laminate material, a coating making up a second portion. Preferably, the coating includes a polyolefin, polyester, nylon, ethylene vinyl alcohol, or combinations thereof, and the first and second portions being disposed adjacent each other. In some embodiments, the layer 908 provides a liquid barrier and is a microporous layer or a monolithic layer that is capable of allowing water vapor to pass there-through.

The smart vapor retarder can be in the form of a coating or film. The smart vapor retarder can be configured to have a water moisture vapor permeability that varies in direct relationship with increases and/or decreases of ambient humidity conditions. Such water moisture vapor permeability transformation allows for drying to occur through the process of vapor diffusion; thereby, improving the speed of drying of the insulation and building materials. The coating or film allows trapped moisture to escape, thereby alleviating a consequent formation of mold and water damage typically resulting from excess trapped moisture. Some exemplary smart vapor retarders include those described in U.S. Pat. Nos. 6,890,666; 6,878,455; and 6,808,772; and United States Patent Application No. 2007/0015424. In some embodiments, when relative humidity is low, the smart vapor retarder provides high resistance to vapor penetration from the interior, and when relative humidity increases the permeance of the smart vapor retarder increases, thus allowing water vapor to pass through, which facilitates drying. For example, the material of the smart vapor retarder can swell and become porous upon contact with moisture.

In one exemplary embodiment, the base layer is a smart vapor retarder that provides permeance to water vapor that increases with ambient relative humidity, and can be advantageous in relatively quick drying walls. The smart vapor retarder can be a coating or layer that includes nylon, ethylene vinyl alcohol (EVOH) or copolymers thereof. In some embodiments, one or more of the CD and/or MD tapes are made of such smart vapor retarder materials.

In specific embodiments, the fabric is made up of a network of a first material and a second material. The first material has a first thickness and is oriented in the machine (i.e., relative to and transverse to a downstream or direction of drainage (or vertical) when installed) including a polyolefin, polyester, nylon or combinations thereof, the machine direction material. Preferably, the material in the other direction (cross-machine, transverse or direction of drainage) includes a polyolefin, polyester, nylon or combinations thereof, and is characterized by a second thickness. In a further aspect, this second thickness is at least two times greater than the first thickness so as to assist in providing drainage for moisture build-up. The present disclosure provides various improvements to this basic design, including in the selection of materials for system components, their geometry and topography, and modification to material surfaces.

### Methods of Making and Installing the Protective Drainage Wrap

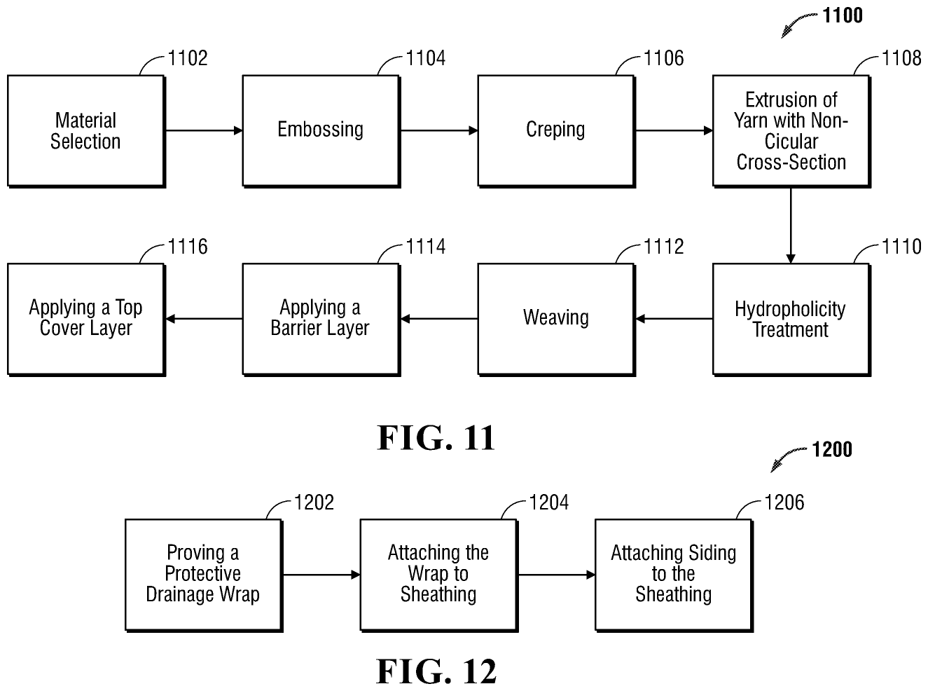

Embodiments of the present disclosure include methods of making and installing the protective drainage wraps disclosed herein. With reference to FIG. 11, a method 1100 of forming the wrap is depicted.

The method can include a material selection step 1102. The material selection can include selecting materials for the CD tape, MD tape, yarn, backing layer, top layer, or combinations thereof. The CD and MD tapes can be selected to have a desired hydrophobicity and/or hydrophilicity. The yarn can be selected to have a desired non-circular cross section.

In the embodiments where yarn is supported by a CD tape, the yarn and the tape can be combined by appropriate layering at element 1388 prior to feeding the layered structure into the loom for weaving.

The method can include an embossing step 1104 that includes embossing selected weft (CD tapes) of the cross-woven web. For example, the selected CD tapes can be embossed as the CD tapes are being unwound from a spool to feed to the shuttle during the weaving process. In embodiments in which the yarn is supported (e.g., nestled) on an embossed CD tape, the yarn can be sourced from a spool and can be laid into the embossed trough of the CD tape after the embossing of the CD tape has been performed. In some embodiments, the tapes are embossed before weaving. In other embodiments, the tapes are embossed after weaving. The tapes can be made of a thermoplastic material, such that the embossing can be accomplished using a die with heat and pressure. In embodiments where CD tapes positioned between yarn elements are embossed, the embossing can be performed either before or after weaving by passing the CD tape material through an embossing unit. In some embodiments when the tape is embossed after weaving, the embossing is performed prior to the prior to the addition of the base layer. The embossing provides both drainage channels at the front side of the protective drainage wrap and protrusions at the back side of the protective drainage wrap for added back spacing to promote air drying.

The method can include a creping step 1106, including creping at least some of the MD tapes of the cross-woven web. For example, the tapes can be creped prior to the weaving process, such as by passing the tapes through a crepe unit prior to passing the tapes to the loom. The creping can be performed on the MD tapes such that the orientation of the creping ridges in the MD tape is directed downward, in the CD direction, and such that the drainage is directed to flow downwards. Some examples of creped spunbond are described in U.S. Pat. Nos. 6,197,404; and 6,838,154. In some embodiments, Micrex can be applied to film creping. See U.S. Pat. No. 3,260,778.

The method can include a yarn extrusion step 1108, including extruding a polymer melt from a die to produce a continuous synthetic yarn having a non-circular cross-section.

The method can include a hydrophilicity treatment step 1110. In embodiments where some of the tapes are hydrophilic and some are hydrophobic, a first spool can be used to dispense the hydrophilic material and a second spool can be used to dispense the hydrophobic material. In some embodiments, the materials used as the tapes are selected such that the materials exhibit the desired properties (e.g., hydrophobicity or hydrophilicity). In other embodiments, materials are treated to provide the materials with the desired properties. For example, a hydrophobic material can be subjected to in situ hydrophilization (e.g., by treating the tapes) prior to the weaving process. A material that is subjected to hydrophilization is referred to herein as a hydrophilized material. A hydrophilized material exhibits increased hydrophilicity after hydrophilization relative to the hydrophilicity of the material prior to hydrophilization.

The hydrophilicity or hydrophobicity of the tapes can be a result of the polymer type and composition (e.g., material additives added to the polymer melt) of the tapes or of external treatment of the tapes. Some exemplary hydrophilic (contact angle <90 degrees) polymer types are EVOH (48), PVOH (51), Nylon 6,6 (68), and PET (73). Some exemplary hydrophobic (contact angle >90 degrees) polymer types are PE (96) and PP (102). Some exemplary hydrophilizing additives are Irgasurf PF3155 and Techsurf PPM15560. The additives can be added to the polymer melt to confer hydrophilicity to hydrophobic polymers. For example, hydrophilization of polypropylene can be achieved with a mixture of various ethoxylated alcohols of structure CH₃—CH₂—(CH₂—CH₂)ₘ—CH₂CH₂—(OCH₂CH₂)ₙ—OH where m is between 9 and 35 and n is between 1 and 10. Other additives that can be used for the hydrophilization of a surface include organosilicones, polyethylene glycols, fatty acid monoglycerides or alkoxylated alkyl phenols. An exemplary hydrophilic masterbatch for polypropylene is one sold by Polyvel under the trade name VW-351. An exemplary hydrophobic additive is Goulston Hydrepel, which can be used to increase the hydrophobicity of polymers, such as polypropylene. Exemplary external treatments that can be used to provide hydrophilicity include plasma treatment and corona treatment. Plasma treatment is effective at increasing hydrophilic properties. In some embodiments, the method includes providing for a gradient hydrophilicity, such that the hydrophilicity of the yarn elements are greater than the hydrophilicity of the CD tape beneath the yarn, and such that the hydrophilicity of the CD tapes are progressively less hydrophilic the further from a yarn they are positioned.

The method can include forming the cross-woven web. Formation of the cross woven web can include a weaving step 1112 that includes weaving together a plurality of CD tape with a plurality of MD tape and a plurality of yarn elements extending in the CD direction. The weaving process can be performed using a flat loom, for example. In some embodiments, the yarn is inserted in the CD direction using a shuttle. When weaving the yarn into the cross-woven base web, the method can include positioning the strands of yarn onto a CD tape.

The method can include barrier step 1114 including providing a barrier layer onto the back side of the cross-woven web. For example, the barrier layer can be a breathable coating, such as a microporous film, that is bonded to the back of the cross-woven web using hot melt.

The method can include covering step 1116 including providing a top layer onto the front side of the cross-woven web. For example, the top layer can be a creped spunbond nonwoven, and can be attached to the cross-woven web and/or the backing layer.

Some embodiments include a method of installing a protective drainage wrap. FIG. 12 is a flow chart of a method 1200 of installing a protective drainage wrap. Method 1200 can include providing a protective drainage wrap, step 1202. The protective drainage wrap can be in accordance with any of the protective drainage wraps disclosed herein. The method can include attaching the protective drainage wrap to sheathing of structure, step 1204. The attaching can be performed via stapling, nailing, screwing or otherwise securing the protective drainage wrap to the sheathing. The method can include attaching siding to the structure such that the protective drainage wrap is positioned between the siding and the sheathing, step 1206. The protective drainage wrap can be positioned to provide various air channels between the protective drainage wrap and the sheathing and between the protective drainage wrap and the siding.

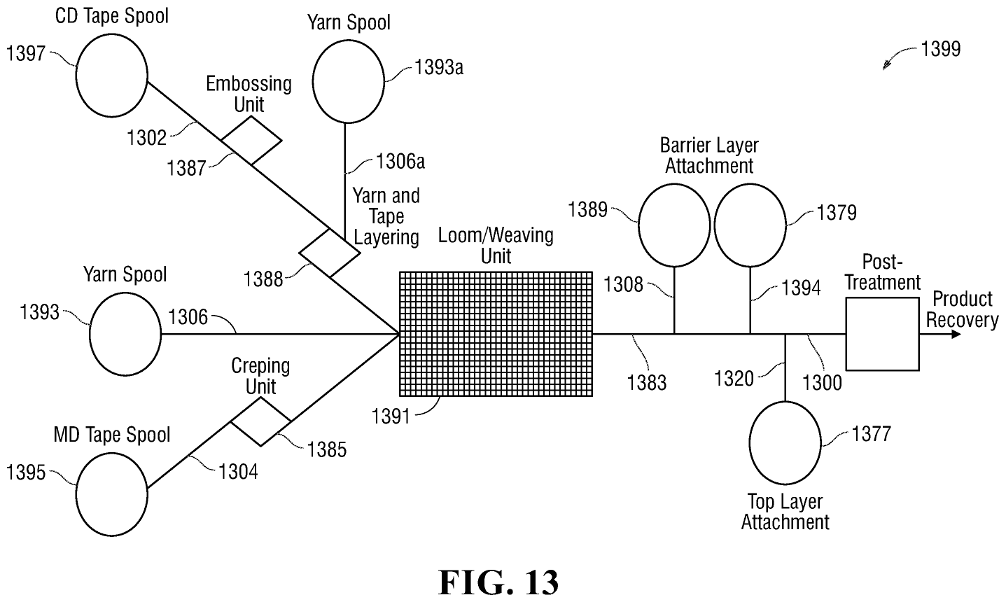

FIG. 13 is a simplified diagram of a system configured to manufacture the protective drainage wrap disclosed herein. System 1399 includes spool 1397 for dispensing CD tape 1302, spool 1395 for dispensing MD tape 1304, and spool 1393 for dispensing yarn 1306. Each of the CD tape 1302, MD tape 1304, and yarn 1306 are dispensed to the loom 1391. Prior to passing to the loom 1391, CD tape 1302 passes through an embossing unit 1387 to emboss the CD tape 1302. Prior to passing to the loom 1391, MD tape 1304 passes through a creping unit 1385 to crepe the MD tape 1304. The loom 1391 operates to weave the CD tape 1302, MD tape 1304, and yarn 1306 together to form the cross-woven base web 1383 with yarn 1306. The cross-woven base web 1383 is coupled with the barrier layer 1308 dispensed from spool 1389, nonwoven sheet 1394 dispensed from spool 1379, and top layer 1320 dispensed from spool 1377. The protective drainage wrap 1300 can then be optionally subjected to post-treatments 1375 prior to recovery of the protective house wrap 1300. The post-treatments 1375 can include embossing, creping, or other processes.

The foregoing has been presented for purposes of illustration and description. These descriptions are not intended to limit the disclosure or aspects of the disclosure to the specific barrier protection systems or system components, constructions or articles, apparatus and processes disclosed. Various aspects of the disclosure are intended for applications other than the specific systems, constructions and fabrics referred to above. Certain manufacturing techniques and structural features and designs described may also be incorporated into or with other barrier protection systems, and other weather resistant material systems incorporating fabrics and layers, assemblies, or combinations thereof. The specific systems described may also incorporate different components in alternate designs according to the present description. These and other variations of the disclosure will become apparent to one generally skilled in the relevant building and construction trade and art, when provided with the present disclosure. Consequently, variations and modifications commensurate with the above teachings, and the skill and knowledge of the relevant art, are within the scope of the present disclosure. The embodiments described and illustrated herein are further intended to explain best or preferred modes for practicing the disclosure, and to enable others skilled in the art to utilize the disclosure and other embodiments and with various modifications required by the particular applications or uses of the present disclosure.

Although the present embodiments and advantages have been described in detail, it should be understood that various changes, substitutions and alterations can be made herein without departing from the spirit and scope of the disclosure. Moreover, the scope of the present application is not intended to be limited to the particular embodiments of the systems, process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A protective drainage wrap, the wrap comprising:
a base web comprising cross-woven or cross-laminate tape elements including first tape elements extending in a drainage direction and second tape elements extending in a direction that is transverse to the drainage direction, the base web presenting a front surface and a back surface respectively defining a front and back of the base web; and
a plurality of spaced apart, elongated drainage strands supported on the front of the web and extending in the drainage direction, wherein the strands are hydrophilic.

2. The wrap of claim 1, further comprising a vapor-permeable and liquid-impermeable material barrier situated adjacent the base web on the back surface thereof.

3. The wrap of claim 2, wherein the material barrier comprises a microporous film.

4. (canceled)

5. The wrap of claim 2, wherein the material barrier comprises a non-porous monolithic film that is permeable to water molecules via molecular diffusion.

6. (canceled)

7. The wrap of claim 5, wherein the monolithic film comprises a material that exhibits molecular diffusion properties that vary with ambient humidity.

8. (canceled)

9. The wrap of claim 1, wherein said drainage strands are elongated hydrophilic yarns comprising fibers having a non-circular cross-section.

10. The wrap of claim 9, wherein the yarns have capillary voids between the fibers.

11. The wrap of claim 9, wherein the fibers are multi-lobal fibers.

12-14. (canceled)

15. The wrap of claim 9, wherein the fibers have a shape factor of greater than 1.

16. The wrap of claim 1, wherein each said drainage strand is situated directly above and on a front surface of one of the first tape elements.

17. (canceled)

18. The wrap of claim 16, wherein said drainage strands are supported on a first tape element that is hydrophilic.

19-22. (canceled)

23. The wrap of claim 16, wherein said drainage strands are supported on a first tape element that is hydrophobic.

24-28. (canceled)

29. The wrap of claim 1, wherein the base web comprises troughs in at least some of the first tape elements.

30. (canceled)

31. (canceled)

32. The wrap of claim 29, wherein at least some of the troughs are situated between the drainage strands, and wherein the first tape elements having troughs situated between the drainage strands are hydrophobic.

33. The wrap of claim 32, wherein the troughs situated between the drainage strands define channels for gravity-driven liquid flow and for air-drying.

34. The wrap of claim 29, wherein at least some of the troughs are situated beneath the drainage strands such that the drainage strands are at least partially in the troughs, and wherein the first tape elements having troughs situated beneath the drainage strands are hydrophilic.

35. (canceled)

36. The wrap of claim 29, wherein the troughs are defined by embossed first tape elements.

37. The wrap of claim 1, wherein at least a portion of the drainage strands extend above the front surface of the base web.

38-44. (canceled)

45. The wrap of claim 1, wherein at least some of the second tape elements are hydrophilic.

46-58. (canceled)

59. A protective drainage wrap, the wrap comprising:
a base web comprising cross-woven or cross-laminate tape elements including first tape elements extending in a drainage direction and second tape elements extending in a direction transverse to the drainage direction, wherein a front surface of said base web is characterized by a plurality of spaced apart troughs each extending in the drainage direction.

60. The wrap of claim 59, wherein each said trough is formed by a concave depression on a front surface of one of said first tape elements.

61. The wrap of claim 59, further comprising a plurality of spaced apart, elongated drainage yarns situated frontward of the base web and extending in the drainage direction.

62-64. (canceled)

65. The wrap of claim 61, wherein said yarns are situated in front of said troughs.

66. The wrap of claim 65, wherein said troughs are formed in hydrophilic tape elements extending in the drainage direction.

67. The wrap of claim 65, wherein the first tape elements of said troughs are less hydrophilic than said yarns situated in front of the trough.

68. The wrap of claim 67, wherein the first tape elements adjacent said yarns are hydrophilic tape elements.

69. The wrap of claim 68, wherein said adjacent first tape elements extending alongside said yarns are less hydrophilic than the first tape elements of the trough.

70. (canceled)

71. The wrap of claim 59, wherein said troughs are troughs embossed on said tape elements of said web.

72-139. (canceled)

140. A protective drainage wrap, the wrap comprising:
a base web comprising cross-woven or cross-laminate tape elements including first tape elements extending in a drainage direction and second tape elements extending in a direction that is transverse to the drainage direction, the base web presenting a front surface and a back surface respectively defining a front and back of the base web;
a plurality of spaced apart, elongated drainage strands supported on the front of the web and extending in the drainage direction, wherein the strands are hydrophilic, and wherein each strand is positioned on and supported by one of the first tape elements.

141. (canceled)

142. (canceled)

143. A protective drainage wrap, the wrap comprising:
a base web comprising cross-woven or cross-laminate tape elements including first tape elements extending in a drainage direction and second tape elements extending in a direction that is transverse to the drainage direction, the base web presenting a front surface and a back surface respectively defining a front and back of the base web;
a plurality of spaced apart, elongated drainage strands supported on the front of the web and extending in the drainage direction, wherein the strands are hydrophilic, and wherein each strand comprises fibers having a non-circular cross section with capillary voids between the fibers.

144. (canceled)

145. The wrap of claim 61, wherein at least some of the troughs are positioned intermediate of the yarns.

146. The wrap of claim 61, wherein at least some of the troughs are positioned beneath the yarns, such that the yarns are at least partially within the troughs.

147-157. (canceled)
